(19) United States
(12) Patent Application Publication
(10) Pub. No.: US 2017/0208852 A1
(43) Pub. Date: Jul. 27, 2017

(54) METHODS FOR IMPROVING TOLERANCE OF AN INDIVIDUAL WITH A RECONSTITUTED LIQUID PRODUCT AND RELATED COMPOSITIONS AND METHODS

(71) Applicant: ABBOTT LABORATORIES, Abbott Park, IL (US)

(72) Inventors: CYNTHIA BLACK, Westerville, OH (US); YOUNGSUK HEO, Powell, OH (US); TIMOTHY LAPLANTE, Powell, OH (US); PETER WESTFALL, Westerville, OH (US); GARY KATZ, Columbus, OH (US); SANDRA WEIDA, Delaware, OH (US); CATHERINE LAMB, Westerville, OH (US)

(73) Assignee: ABBOTT LABORATORIES, Abbott Park, IL (US)

(21) Appl. No.: 15/327,842

(22) PCT Filed: Jul. 21, 2015
(86) PCT No.: PCT/US2015/041326

§ 371 Date: Jan. 20, 2017

Related U.S. Application Data
(60) Provisional application No. 62/027,029, filed on Jul. 21, 2014.

(51) Int. Cl. A23L 33/00; A23L 33/19; A23L 33/10; A23L 33/115

(52) U.S. Cl. CPC A23L 33/40; A23L 33/115; A23L 33/19; A23L 33/10; A23V 2002/00

(57) ABSTRACT

Disclosed are nutritional powders and related methods for providing a reconstituted liquid nutritional product with an enhanced air entrainment profile. In certain exemplary embodiments, the nutritional powders and related methods provide reconstituted liquid nutritional products with a specified air entrainment.

### CROSS-REFERENCE TO RELATED APPLICATIONS

This application claims priority to and the benefit of U.S. Provisional Application No. 62/027,029, filed Jul. 21, 2014, the entire content of which is incorporated herein by reference as if recited in its entirety.

### FIELD

The present disclosure relates generally to nutritional powder pods and, more particularly, to methods for improving tolerance in an individual by administering liquid products reconstituted from the nutritional powder pods, which liquid products have an enhanced air entrainment profile. Also disclosed are related methods for reconstituting the liquid products from the nutritional powder pods.

### BACKGROUND

A variety of nutritional compositions designed to provide one or more of primary or supplemental nutrition are commercially available today. These compositions typically contain a balance of proteins, carbohydrates, lipids, vitamins, and minerals tailored to the nutritional needs of the intended consumer, and include product forms such as ready-to-drink liquids, reconstitutable powders, and the like. Among the many nutritional compositions commercially available today, infant formulas (commonly in the form of reconstitutable powders) have become particularly well known and commonly used in providing nutrition early in life.

It is known to reconstitute nutritional compositions in the form of powders with a liquid such as water to render the nutritional compositions fit for consumption. Similar reconstitution may also be achieved for concentrated liquids. The resulting reconstituted liquid product may be a nutritional composition such as an infant formula, a nutritional composition intended for consumption by healthy adults, or a nutritional composition intended for those with particular nutritional needs (e.g., diabetics).

### SUMMARY

The general inventive concepts discussed herein are based, at least in part, on reconstitution of a nutritional powder contained within a nutritional powder pod to provide a reconstituted liquid product with a low amount of air entrainment. The methods of improving tolerance of an individual comprise use of the reconstituted liquid products. Generally, the nutritional powder is contained within a pod and reconstituted by use of a beverage production machine, preferably a single serving beverage production machine.

In a first exemplary embodiment, a method for improving tolerance in an individual upon ingestion of a reconstituted liquid nutritional product is provided. The method comprises using a beverage production machine to reconstitute a nutritional powder contained within a pod with a liquid, thereby forming a reconstituted liquid nutritional product, and providing the reconstituted liquid nutritional product to an individual for consumption. The reconstituted liquid nutritional product formed thereby has an air entrainment of about 0% to about 25%.

In a second exemplary embodiment, a process for reconstituting a nutritional powder from a pod is provided. The process comprises mixing a liquid with a nutritional powder from a nutritional powder pod, thereby forming a reconstituted liquid product, and providing the reconstituted liquid product to an individual for consumption, wherein the reconstituted liquid product has an air entrainment of about 0% to about 25%.

In a third exemplary embodiment, a reconstituted liquid nutritional product is provided. The liquid nutritional product is produced by using a nutritional powder pod with a beverage production machine to reconstitute the nutritional powder to form a reconstituted liquid nutritional product with an air entrainment of about 0% to about 25%.

In a fourth exemplary embodiment, a reconstituted liquid nutritional product comprising an air entrainment of about 0% to about 25% for use in a method for improving tolerance of an individual upon the individual's ingestion of the reconstituted liquid nutritional product is provided.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

FIG. 1 illustrates the bottom and top sections of a bulk density test cylinder.

FIG. 2 illustrates a modified vibration tester used for the vibrated bulk density test method.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The general inventive concepts as described herein are based, in part, on the discovery that reconstituting a nutritional powder contained within a pod with a beverage production machine provides a liquid nutritional product with a level of air entrainment of about 0% to about 25%. The consumer of the resulting liquid nutritional product is provided a more pleasant and tolerable consumption experience than achieved with conventional reconstitution of nutritional powders.

In a first exemplary embodiment, a method for improving tolerance in an individual upon ingestion of a reconstituted liquid nutritional product is provided. The method comprises using a beverage production machine to reconstitute a nutritional powder contained within a pod with a liquid, thereby forming a reconstituted liquid nutritional product, and providing the reconstituted liquid nutritional product to an individual for consumption. The reconstituted liquid nutritional product formed thereby has an air entrainment of about 0% to about 25%.

In a second exemplary embodiment, a process for reconstituting a nutritional powder from a pod is provided. The process comprises mixing a liquid with a nutritional powder from a nutritional powder pod, thereby forming a reconstituted liquid product, and providing the reconstituted liquid product to an individual for consumption, wherein the reconstituted liquid product has an air entrainment of about 0% to about 25%.

In a third exemplary embodiment, a reconstituted liquid nutritional product is provided. The liquid nutritional product is produced by using a nutritional powder pod with a beverage production machine to reconstitute the nutritional powder to form a reconstituted liquid nutritional product with an air entrainment of about 0% to about 25%.

In a fourth exemplary embodiment, a reconstituted liquid nutritional product comprising an air entrainment of about 0% to about 25% for use in a method for improving tolerance of an individual upon the individual's ingestion of the reconstituted liquid nutritional product is provided.

The terms “adult formula” and “adult nutritional product” as used herein, unless otherwise specified, are used interchangeably to refer to nutritional compositions suitable for generally maintaining or improving the health of an adult.

The term “agglomerated” as used herein, unless otherwise specified, refers to a nutritional powder that is processed such that individual powder particles are fused together to form porous aggregates of powder particles. The agglomerated nutritional powders described herein may be produced according to well known processes including, but not limited to, rewetting agglomeration, fluid-bed agglomeration, pressure agglomeration, and instantization by spray lecithination.

The term “bulk density” as used herein, unless otherwise specified, refers to the density of powder or other finely-divided solid without excluding the open space. Bulk density is calculated by dividing the mass of a given portion of a powder by the total powder volume

The term “infant” as used herein, unless otherwise specified, refers to a human about 36 months of age or younger. The term “toddler” as used herein, unless otherwise specified, refers to a subgroup of infants from about 12 months of age to about 3 years of age.

The term “child” as used herein, unless otherwise specified, refers to a human about 3 years of age to about 18 years of age. The term “adult” as used herein, unless otherwise specified, refers to a human about 18 years of age or older.

The terms “infant formula” or “infant nutritional product” as used herein, unless otherwise specified, are used interchangeably to refer to nutritional compositions that have the proper balance of macronutrients, micro-nutrients, and calories to provide sole or supplemental nourishment for and generally maintain or improve the health of infants, toddlers, or both. Infant formulas preferably comprise nutrients in accordance with the relevant infant formula guidelines for the targeted consumer or user population, an example of which would be the Infant Formula Act, 21 U.S.C. Section 350(a).

The term “initiation time” as used herein, unless otherwise specified, refers to the time at which any liquid from a beverage production machine first makes contact with or otherwise impinges upon the contents of a pod.

The terms “liquid product” and “liquid nutritional product” as used herein, unless otherwise specified, are used interchangeably herein and refer to the reconstituted nutritional powder.

The term “nutritional composition” as used herein, unless otherwise specified, refers to nutritional powders and concentrated liquids. The nutritional powders may be reconstituted to form nutritional liquids suitable for oral consumption by a human. The concentrated liquids may be diluted or otherwise augmented to form nutritional liquids suitable for oral consumption by a human.

The term “nutritional powder” as used herein, unless otherwise specified, refers to nutritional compositions that are solids or semisolids in the form of finely divided particles that are generally flowable or scoopable. A nutritional powder is usually reconstituted by addition of water or another liquid to form a liquid product prior to administration to (e.g., providing to or consumption by) an individual. As discussed below, in certain embodiments disclosed herein, the nutritional compositions comprise at least one of a source of protein, a source of carbohydrate, and a source of fat. The nutritional compositions disclosed herein are generally suitable for oral consumption by a human.

The term “nutritional powder pod” as used herein, unless otherwise specified, refers to a pod containing a certain volume or mass of a nutritional powder.

The terms “pediatric formula” or “pediatric nutritional product,” as used herein, unless otherwise specified, are used interchangeably to refer to nutritional compositions suitable for generally maintaining or improving the health of toddlers, children, or both.

The term “pod” as used herein, unless otherwise specified, refers to a sealable, re-sealable or sealed container having an internal volume capable of containing a solid, powder, or liquid formulation that, when mixed with liquid, yields a liquid product suitable for human consumption.

The terms “powder,” “reconstitutable,” and “reconstitutable powder” as used herein, unless otherwise specified, each describe a physical form of a nutritional composition, or portion thereof, that is flowable or scoopable and can be reconstituted with water or other liquid prior to consumption.

The term “reconstitute,” “reconstituted,” and “reconstitution” as used herein, unless otherwise specified, are used interchangeably to refer to a process by which the nutritional powder is mixed with a liquid, typically water, to form an essentially homogeneous liquid product. Once reconstituted in the liquid, the ingredients of the nutritional powder may be any combination of dissolved, dispersed, suspended, colloidally suspended, emulsified, or otherwise blended within the liquid matrix of the liquid product. Therefore, the resulting reconstituted liquid product may be characterized as any combination of a solution, a dispersion, a suspension, a colloidal suspension, an emulsion, or a homogeneous blend.

The term “serving” as used herein, unless otherwise specified, is any amount of a composition that is intended to be ingested by a subject in one sitting or within less than about one hour. The size of a serving (i.e., “serving size”) may be different for diverse individuals, depending on one or more factors including, but not limited to, age, body mass, gender, species, or health. For a typical human child or adult, a serving size of the compositions disclosed herein is from about 25 mL to 1,000 mL. For a typical human infant or toddler, a serving size of the compositions disclosed herein is from about 5 mL to about 250 mL.

The term “suitable for oral consumption” as used herein, unless otherwise specified, refers to the transformation of a formulation (including, but not limited to, a nutritional composition) from a product form not intended for direct oral consumption to a product form intended for direct oral consumption, preferably by a human. For example, reconstituting a reconstitutable powder to form a food product or beverage is considered rendering the reconstitutable powder suitable for oral consumption. As another example, diluting a concentrated liquid to form a food product or beverage is considered rendering the concentrated liquid suitable for oral consumption.

It is intended that when discussing the nutritional powders herein that the discussions apply equally to the methods of the present disclosure, that is, the nutritional powders and nutritional powder pods discussed herein are suitable for use in the disclosed methods. In addition, while the discussion of the general inventive concepts refers to nutritional powders and pods that contain those powders, those of skill in the art will recognize that the general inventive concepts may also pertain to the reconstitution of concentrated liquids.

The compositions of the present disclosure may be packaged and sealed in single or multi-use containers, and then stored under ambient conditions or under refrigeration for up to 36 months or longer, more typically from about 6 months to about 24 months. For multi-use containers, these packages can be opened and then closed for repeated use by the ultimate user. Non-limiting examples of ways in which the present nutritional powder pods may be utilized include their use in a beverage production machine to produce the following liquid products: a hot beverage; a tepid or cool beverage (e.g., an infant formula, a malted beverage, a fruit or juice beverage, a carbonated beverage, a soft drink, or a milk based beverage); a performance beverage (e.g., a performance ready-to-drink beverage); or a functional beverage (e.g., a slimming beverage, a fat burning beverage, a product for improving mental performance or preventing mental decline, or a skin improving product).

In certain embodiments, a package is provided containing a nutritional powder pod. In certain embodiments, a package is provided containing a plurality of nutritional powder pods.

In certain embodiments, a kit is provided comprising a beverage production machine and one or more nutritional powder pods.

### Methods of Improving Tolerance

As mentioned previously, reconstitution of nutritional powders into a liquid nutritional product may result in unintended or undesirable amounts of air entrainment. (While the term “air” entrainment is used herein, those of skill in the art will understand that any gas available in the ambient atmosphere around the reconstitutable powder during the process of reconstitution may be entrained, including, but not limited to air). Entrained air, when ingested along with the reconstituted liquid product, often leads to unwanted feelings of bloating and gassiness on the part of the consumer. This is especially true in the case of infants where entrained air has been implicated in fussiness, colic, spit-up, and vomiting. A reconstitutable nutritional powder that, when reconstituted in a liquid to provide a liquid product with an amount of entrained air of about 0% to about 25%, may provide certain advantages to the consumer. In certain exemplary embodiments, consumption of a reconstituted liquid product according to the disclosed methods results in an improvement in tolerance including, but not limited to, a reduction in one or more of colic, fussiness, intestinal discomfort, spit-up, vomiting, and gassiness.

As discussed above, according to the first exemplary embodiment, a method for improving tolerance in an individual upon ingestion of a reconstituted liquid nutritional product is provided. The method comprises using a beverage production machine to reconstitute a nutritional powder contained within a pod with a liquid, thereby forming a reconstituted liquid nutritional product, and providing the reconstituted liquid nutritional product to an individual for consumption. The reconstituted liquid nutritional product formed thereby has an air entrainment of about 0% to about 25%. In certain embodiments, of the first exemplary embodiment, the individual is an infant, the liquid product is an infant formula, or both.

According to the fourth exemplary embodiment, a reconstituted liquid nutritional product comprising an air entrainment of about 0% to about 25% for use in a method for improving tolerance of an individual upon the individual's ingestion of the reconstituted liquid nutritional product is provided. In certain exemplary embodiments, the reconstituted liquid nutritional product is administered to an individual for consumption. In certain exemplary embodiments, a reconstituted liquid nutritional product for improving tolerance of an individual upon the individual's ingestion of the reconstituted liquid nutritional product, is achieved by reconstituting a nutritional powder contained within a pod using a beverage production machine.

It should be understood that an improvement in tolerance results in a reduction in intolerance. Generally, infant intolerance can be understood as a non-immune system associated reaction that may be evidenced by behavior or by stool or feeding pattern changes, such as increased spit-up or vomiting, an increased number of stools, more watery stools, black stools, and increased fussiness. An infant's intolerance (to a given infant formula) is most often associated with gastrointestinal symptoms (e.g., stool patterns, gas, spit-up) as well as behavior characteristics (e.g., acceptance of formula, fussing and crying). Infants suffering from intolerance may also experience gastroesophageal reflux.

In certain embodiments as disclosed herein, the improvement in tolerance can be measured by a reduction in one or more symptoms that are generally associated with infant intolerance: colic, fussiness, intestinal discomfort, spit-up, vomiting, and gassiness. In certain embodiments, the improvement in tolerance is a reduction in colic. In certain embodiments, the improvement in tolerance is an improvement in fussiness. In certain embodiments, the improvement in tolerance is an improvement in intestinal discomfort. In certain embodiments, the improvement in tolerance is an improvement in spit-up. In certain embodiments, the improvement in tolerance is an improvement in vomiting. In certain embodiments, the improvement in tolerance is an improvement in gassiness. In certain embodiments, the improvement in tolerance can be measured by a reduction of at least 10% in one or more symptoms that are generally associated with infant intolerance: colic, fussiness, intestinal discomfort, spit-up, vomiting, and gassiness. In certain embodiments, the improvement in tolerance can be measured by a reduction of at least 20% in one or more symptoms that are generally associated with infant intolerance: colic, fussiness, intestinal discomfort, spit-up, vomiting, and gassiness. The improvements can be measured as compared to a different time period when a reconstituted liquid product made from a nutritional powder without using a beverage production machine is fed to the infant. In certain embodiments, the improvement can be measured by using comparative animal testing.

### Pod

As discussed above, the present disclosure relates to nutritional powders contained within a pod which are suitable for use in beverage production machines. In certain embodiments, the contents of the pod (i.e., the nutritional powder) is intended to be processed (i.e., rendered suitable for oral consumption by an individual) within seconds after the hermetic seal of the pod is broken to allow liquid to flow therein, the content to flow therefrom, or a combination thereof. In such embodiments, the pod will typically be a single-use, disposable container. In other embodiments, the pod is sealable or re-sealable and is capable of re-use. In certain embodiments where the pod is sealable or re-sealable, the contents of the pod (i.e., the nutritional powder) may be stored for a short time (typically hours or days) by the consumer prior to reconstituting into a liquid product and the pod may or may not be hermetically sealed at any point.

In certain embodiments, the pod may be configured to receive an injector or similar device through which water, air, or other fluids (e.g., steam) may be introduced to facilitate mixing and reconstitution within the enclosed volume of the pod. In certain embodiments, the liquid introduced to the pod may be pre-filtered, or alternatively the fluid may pass through a filtration unit disposed within the pod. In certain embodiments, an outlet member integrally formed as part of or movably coupled to the pod may be positioned for dispensing from the pod.

In certain embodiments, any delay between the time the hermetic seal of the pod is disrupted and the initiation time is less than 1 second. In other embodiments, any delay between the time the hermetic seal of the pod is disrupted and the initiation time is less than 2 seconds. In other embodiments, any delay between the time the hermetic seal of the pod is disrupted and the initiation time is less than 3 seconds. In other embodiments, any delay between the time the hermetic seal of the pod is disrupted and the initiation time is less than 4 seconds. In other embodiments, any delay between the time the hermetic seal of the pod is disrupted and the initiation time is less than 5 seconds. In other embodiments, any delay between the time the hermetic seal of the pod is disrupted and the initiation time is within the range of 1 second to 10 seconds. In some embodiments, a delay between the time the hermetic seal of the pod is disrupted and the initiation time is within the range of 1 second to 30 seconds.

In certain embodiments, the pod contains an amount of nutritional powder corresponding to a single serving. The amount of nutritional powder corresponding to a single serving may vary, for example, based on the intended consumer (e.g., an infant, a toddler, a child, an adult, a healthy individual, a sick individual). In some instances, more nutritional powder than is needed for a single serving may be included in the pod, such as when an ingredient of the formulation is likely to degrade or otherwise lose effectiveness over time.

In certain embodiments, the pod encloses an amount of a nutritional powder that is suitable for being reconstituted into a single serving of a liquid product upon combination with a certain volume of liquid. In certain embodiments, the pods contain about 2 grams to about 150 grams of nutritional powder, including about 2 grams to about 100 grams, including about 2 grams to about 80 grams, including about 2 grams to about 60 grams, including about 2 grams to about 50 grams, including about 2 grams to about 35 grams, including about 2 grams to about 30 grams, including about 2 grams to about 25 grams, including about 2 grams to about 20 grams, including about 2 grams to about 15 grams, including about 2 grams to about 10 grams, including about 5 grams to about 150 grams, including about 5 grams to about 100 grams, including about 5 grams to about 80 grams, including about 5 grams to about 60 grams, including about 5 grams to about 50 grams, including about 5 to about 35 grams, including about 5 to about 30 grams, including about 5 to about 25 grams, including about 5 to about 20 grams, including about 5 grams to about 15 grams, including about 10 grams to about 150 grams, including about 10 grams to about 100 grams, including about 10 grams to about 80 grams, including about 10 grams to about 60 grams, including about 10 grams to about 50 grams, including about 10 grams to about 40 grams, including about 10 grams to about 35 grams, including about 10 grams to about 30 grams, including about 10 grams to about 25 grams, including about 10 grams to about 20 grams, including about 15 grams to about 150 grams, including about 15 grams to about 100 grams, including about 15 grams to about 80 grams, including about 15 grams to about 60 grams, including about 15 grams to about 50 grams, including about 15 grams to about 40 grams, including about 15 grams to about 35 grams, including about 15 grams to about 30 grams, including about 15 grams to about 25 grams, including about 20 grams to about 150 grams, including about 20 grams to about 100 grams, including about 20 grams to about 80 grams, including about 20 grams to about 60 grams, including about 20 grams to about 50 grams, including about 20 grams to about 40 grams, including about 20 grams to about 35 grams, including about 20 grams to about 30 grams, including about 25 grams to about 150 grams, including about 25 grams to about 100 grams, including about 25 grams to about 80 grams, including about 25 grams to about 60 grams, including about 25 grams to about 50 grams, including about 25 grams to about 40 grams, including about 25 grams to about 35 grams, including about 30 grams to about 150 grams, including about 30 grams to about 100 grams, including about 30 grams to about 80 grams, including about 30 grams to about 60 grams, including about 30 grams to about 50 grams, including about 30 grams to about 40 grams, including about 40 grams to about 150 grams, including about 40 grams to about 100 grams, including about 40 grams to 80 grams, including about 40 to 60 grams, including about 40 to 50 grams, including about 50 to 150 grams of nutritional powder, and including about 50 to 100 grams of nutritional powder. In certain embodiments, the pods contain about 8 grams, about 10 grams, about 12 grams, about 15 grams, about 20 grams, about 25 grams, about 30 grams, about 35 grams, about 40 grams, about 50 grams, about 60 grams, about 80 grams, about 90 grams, about 100 grams, about 125 grams, or about 150 grams of nutritional powder.

### Nutritional Powders

As discussed above, the nutritional powder pods of the present disclosure comprise a nutritional powder. In certain embodiments, the nutritional powder contained within the pod is in the form of a flowable or substantially flowable powder. In certain embodiments, the nutritional powder is in the form of a powder that can be easily scooped and measured with a spoon or similar other device, such that the nutritional powder can accurately measured for reconstitution with a suitable liquid, typically water, to form a liquid product for immediate consumption. In this context, “immediate” consumption generally means within about 48 hours, more typically within about 24 hours, in some embodiments within about 1 hour, and in some embodiments, immediately after reconstitution.

Generally, the nutritional powders of the present disclosure will have a caloric density tailored to the nutritional needs of the intended user, or will provide such caloric density upon reconstitution with a liquid, such as water. For example, when the nutritional powder is an infant formula, the caloric density will generally be at least about 19 kcal/fl oz (about 640 kcal/liter), more typically from about 20 kcal/fl oz (676 kcal/liter) to about 25 kcal/fl oz (about 845 kcal/liter), even more typically from about 20 kcal/fl oz (about 676 kcal/liter) to about 24 kcal/fl oz (about 810 kcal/liter). Infant formulas having a caloric density of from about 22 kcal/fl oz (about 745 kcal/liter) to about 24 kcal/fl oz (about 810 kcal/liter) are more commonly used for pre-term or low birth weight infants, and infant formulas having a caloric density of from about 20 kcal/fl oz (about 676 kcal/liter) to about 21 kcal/fl oz (about 710 kcal/liter) are more often used for term infants. When the nutritional powder is a pediatric formula or an adult nutritional product, the nutritional powder may have any caloric density suitable for a child or an adult.

### Physical Characteristics of Nutritional Powders

The nutritional powders of the present disclosure may be characterized by certain physical characteristics. In certain embodiments, the nutritional powder of the nutritional powder pod has a defined interstitial void fraction. Generally, it has been found that this property may impact the reconstitution of the nutritional powder contained in the pod into a liquid product by use of a beverage production machine. The interstitial void fraction may affect such physical parameters of the powder as wettability, and of the resulting liquid product as amount of foam and amount of entrained air. In particular, it has been found that nutritional powder according to the embodiments discussed herein provides a reconstituted liquid nutritional product having an air entrainment of 0% to 25%.

The bulk density of a given portion of a nutritional powder is the mass of the given portion of nutritional powder per its total powder volume. Several industry standard methods for measuring these two bulk density values exist including, but not limited to, ASTM D6683-14, “Standard Test Method for Measuring Bulk Density Values of Powders and Other Bulk Solids as a Function of Compressive Stress,” and GEA Niro Analytical Method A 2 A, “Powder Bulk Density.”

One specific type of bulk density measurement is vibrated bulk density according to the test method described more fully in the Test Methods section below. The advantage of measuring vibrated bulk density is that it is generally reproducible and provides consistent results between operators.

While contained within the nutritional powder pod, the nutritional powder will take up a defined amount of space and the remaining space within the nutritional powder pod can be considered head space. In certain exemplary embodiments, the ratio of a volume of the pod to a volume of the nutritional powder contained within the nutritional powder pod is within the range of 19:1 to 99:1.

Air entrainment may be quantified by measuring the compressibility of a given liquid. This value is generally provided as a percentage and measures the percent reduction in volume of a given quantity of liquid product after compression according to a given test method. One specific procedure for determining the air entrainment of a nutritional powder is described more fully in the Test Methods section below.

In certain exemplary embodiments, the inventive concepts include a nutritional product pod containing nutritional powder that is suitable for reconstitution into a liquid product within the pod and the reconstituted liquid product has an air entrainment of about 0% to about 25% after reconstitution with a liquid, including about 0% to about 15%, including about 0% to about 10%, including about 0.6% to about 25%, including about 0.6% to about 15%, including about 0.6% to about 10%, including about 1% to about 20%, including about 1% to about 19%, including about 1% to about 18%, including about 1% to about 17%, including about 1% to about 16%, including about 1% to about 15%, including about 1% to about 14%, including about 1% to about 13%, including about 1% to about 12%, including about 1% to about 11%, including about 1% to about 10%, including about 1% to about 9%, including about 1% to about 8%, including 1% to about 7%, including about 1% to about 6%, including about 1% to about 5%, including about 1% to about 4%, including about 1% to about 3%, including about 1% to about 2%. In certain embodiments, the air entrainment measurement is taken within 3 minutes, preferably within 60 seconds of the reconstituted liquid product exiting a beverage production machine.

Another measurement of the amount (volume) of air in a given reconstituted liquid product is the amount of foam that is present after, for example, reconstitution of a nutritional powder to form the liquid product. Specific methods for measuring the amount of foam present in a reconstituted liquid product are described more fully in the Test Methods section below.

In certain exemplary embodiments, the reconstituted liquid nutritional products have a foam volume of about 0 mL to about 70 mL. In certain exemplary embodiments, the reconstituted liquid nutritional products have a foam volume of about 0 mL to about 60 mL, including about 0 mL to about 50 mL, including about 0 mL to about 25 mL, including about 0 mL to about 15 mL, including about 0 mL to about 10 mL, including about 0 mL to about 5 mL.

Another way to characterize a reconstituted liquid nutritional product is to characterize it by a ratio of the amount of foam (% volume) to the amount of entrained air (% volume). In certain exemplary embodiments, the reconstituted liquid nutritional product has a ratio of amount of foam to entrained air of about 0 to about 80:1, including a ratio of about 5:1 to about 80:1, including a ration of about 10:1 to about 80:1, including a ratio of about 20:1 to about 80:1, including a ratio of about 30:1 to about 80:1, including a ratio of about 40:1 to about 80:1, including a ratio of about 50:1 to about 80:1, including a ratio of about 60:1 to about 80:1, including a ratio of about 70:1 to about 80:1, including a ratio of less than about 70:1 (i.e., 0 to 70:1), including a ratio of less than about 60:1, including a ratio of less than about 50:1, including a ratio of less than about 40:1, including a ratio of less than about 30:1, including a ratio of less than about 20:1, including a ratio of less than about 10:1.

### Composition of Nutritional Powders

In certain embodiments, the nutritional powder of the nutritional powder pod is one of the following: an infant formula, a pediatric formula, an adult nutritional formula, a preterm infant formula, an elemental formula, a semi-elemental formula, or a nutritional supplement. In certain embodiments, when the nutritional powder is an infant formula, the nutritional powder pod, the packaging for the nutritional powder pods, or both are labeled with information indicating that the formula within is an infant formula and is intended for consumption by infants. In certain embodiments, when the nutritional powder is a pediatric formula, the nutritional powder pod, the packaging for the nutritional powder pods, or both are labeled with information indicating that the formula within is a pediatric formula and is intended for consumption by toddlers, children, or both. In certain embodiments, when the nutritional powder is an adult nutritional formula, the nutritional powder pod, the packaging for the nutritional powder pods, or both are labeled with information indicating that the formula within is an adult nutritional formula and is intended for consumption by adults.

### Macronutrients

As discussed above, in certain embodiments, the nutritional powder comprises one or more macronutrients selected from the group of protein, carbohydrate, fat, and mixtures thereof. In certain embodiments, the nutritional powders comprise at least one source of protein, at least one source of carbohydrate, and at least one source of fat. Generally, any source of protein, carbohydrate, or fat that is suitable for use in nutritional products is also suitable for use herein, provided that such macronutrients are also compatible with the essential elements of the nutritional powders as defined herein.

Although total concentration or amounts of protein, carbohydrates, and fat may vary depending upon the nutritional needs of the particular individual for whom the nutritional powder is formulated, such concentrations or amounts most typically fall within one of the following embodied ranges, inclusive of any other essential protein, carbohydrate, or fat ingredients as described herein.

In certain embodiments, when the nutritional powder is formulated as an infant formula, the protein component is typically present in an amount of from about 5% to about 35% by weight of the infant formula (i.e., powder infant formula), including from about 10% to about 30%, from about 10% to about 25%, from about 15% to about 25%, from about 20% to about 30%, from about 15% to about 20%, and also including from about 10% to about 16% by weight of the infant formula (i.e., powder infant formula). The carbohydrate component is typically present in an amount of from about 40% to about 75% by weight of the infant formula (i.e., powder infant formula), including from about 45% to about 75%, from about 45% to about 70%, from about 50% to about 70%, from about 50% to about 65%, from about 50% to about 60%, from about 60% to about 75%, from about 55% to about 65%, and also including from about 65% to about 70% by weight of the infant formula (i.e., powder infant formula). The fat component is typically present in an amount of from about 10% to about 40% by weight of the infant formula (i.e., powder infant formula), including from about 15% to about 40%, from about 20% to about 35%, from about 20% to about 30%, from about 25% to about 35%, and also including from about 25% to about 30% by weight of the infant formula (i.e., powder infant formula).

In certain embodiments, when the nutritional powder is formulated as a pediatric formula, the protein component is typically present in an amount of from about 5% to about 30% by weight of the pediatric formula (i.e., powder pediatric formula), including from about 10% to about 25%, from about 10% to about 20%, from about 10% to about 15%, from about 15% to about 20%, and also including from about 12% to about 20% by weight of the pediatric formula (i.e., powder pediatric formula). The carbohydrate component is typically present in an amount of from about 40% to about 75% by weight of the pediatric formula, including from about 45% to about 70%, from about 50% to about 70%, from about 55% to about 70%, and also including from about 55% to about 65% by weight of the pediatric formula (i.e., powder pediatric formula). The fat component is typically present in an amount of from about 10% to about 25% by weight of the pediatric formula (i.e., powder pediatric formula), including from about 12% to about 20%, and also including from about 15% to about 20% by weight of the pediatric formula (i.e., powder pediatric formula).

Additional suitable ranges for proteins, carbohydrates, and fats in those embodiments where the nutritional powder is formulated as an infant formula or a pediatric formula, based on the percentage of total calories of the nutritional powder, are set forth in Table 1.

TABLE 1

| | Embodiment A | Embodiment B | Embodiment C |
|---|---|---|---|
| Macronutrient | (% Calories) | (% Calories) | (% Calories) |
| Protein | 2-75 | 5-50 | 7-40 |
| Carbohydrate | 1-85 | 30-75 | 35-65 |
| Fat | 5-70 | 20-60 | 25-50 |

Note:
Each numerical value in the table is preceded by the term “about.”

In certain embodiments, when the nutritional powder is formulated as an adult nutritional product (i.e., powder adult nutritional product), the protein component is typically present in an amount of from about 5% to about 35% by weight of the adult nutritional product (i.e., powder adult nutritional product), including from about 10% to about 30%, from about 10% to about 20%, from about 15% to about 20%, and including from about 20% to about 30% by weight of the adult nutritional product (i.e., powder adult nutritional product). The carbohydrate component is typically present in an amount of from about 40% to about 80% by weight of the adult nutritional product (i.e., powder adult nutritional product), including from about 50% to about 75%, from about 50% to about 65%, from about 55% to about 70%, and also including from 60% to 75% by weight of the adult nutritional product (i.e., powder adult nutritional product). The fat component is typically present in an amount of from about 0.5% to about 20%, including from about 1% to about 15%, from about 1% to about 10%, from about 1% to about 5%, from about 5% to about 20%, from about 10% to about 20%, and also including from about 15% to about 20% by weight of the adult nutritional product (i.e., powder adult nutritional product).

Additional suitable ranges for proteins, carbohydrates, and fats in those embodiments where the nutritional powder is formulated as an adult nutritional product, based on the percentage of total calories of the nutritional powder, are set forth in Table 2.

TABLE 2

| | Embodiment D | Embodiment E | Embodiment F |
|---|---|---|---|
| Macronutrient | (% Calories) | (% Calories) | (% Calories) |
| Protein | 1-98 | 5-80 | 15-55 |
| Carbohydrate | 1-98 | 0-75 | 20-50 |
| Fat | 1-98 | 20-70 | 25-40 |

Note:
Each numerical value in the table is preceded by the term “about.”

In certain embodiments, the nutritional powder includes protein or a source of protein. Generally, any source of protein may be used so long as it is suitable for oral nutritional compositions and is otherwise compatible with any other selected ingredients or features in the nutritional composition. Non-limiting examples of suitable proteins (and sources thereof) suitable for use in the nutritional powders described herein include, but are not limited to, intact, hydrolyzed, or partially hydrolyzed protein, which may be derived from any known or otherwise suitable source such as milk (e.g., casein, whey), animal (e.g., meat, fish), cereal (e.g., rice, corn, wheat), vegetable (e.g., soy, pea, potato, bean), and combinations thereof. The protein may also include a mixture of amino acids (often described as free amino acids) known for use in nutritional products or a combination of such amino acids with the intact, hydrolyzed, or partially hydrolyzed proteins described herein. The amino acids may be naturally occurring or synthetic amino acids.

More particular examples of suitable protein (or sources thereof) used in the nutritional powders disclosed herein include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, potassium caseinates, legume protein, soy protein concentrates, soy protein isolates, pea protein concentrates, pea protein isolates, collagen proteins, potato proteins, rice proteins, wheat proteins, canola proteins, quinoa, insect proteins, earthworm proteins, fungal (e.g., mushroom) proteins, hydrolyzed yeast, gelatin, bovine colostrum, human colostrum, glycomacropeptides, mycoproteins, proteins expressed by microorganisms (e.g., bacteria and algae), and combinations thereof. The nutritional powders described herein may include any individual source of protein or combination of the various sources of protein listed above.

In addition, the proteins for use herein can also include, or be entirely or partially replaced by, free amino acids known for use in nutritional products, non-limiting examples of which include L-tryptophan, L-glutamine, L-tyrosine, L-methionine, L-cysteine, taurine, L-arginine, L-carnitine, and combinations thereof

In certain embodiments, the nutritional powders described herein include a protein component that consists of only intact or partially hydrolyzed protein; that is, the protein component is substantially free of any protein that has a degree of hydrolysis of 25% or more. In this context, the term “partially hydrolyzed protein” refers to proteins having a degree of hydrolysis of less than 25%, including less than 20%, including less than 15%, including less than 10%, and including proteins having a degree of hydrolysis of less than 5%. The degree of hydrolysis is the extent to which peptide bonds are broken by a hydrolysis chemical reaction. To quantify the partially hydrolyzed protein component of these embodiments, the degree of protein hydrolysis is determined by quantifying the amino nitrogen to total nitrogen ratio (AN/TN) of the protein component of the selected nutritional powder. The amino nitrogen component is quantified by USP titration methods for determining amino nitrogen content, while the total nitrogen component is determined by the Tecator® Kjeldahl method. These analytical methods are well known.

In certain embodiments, the nutritional powder includes a carbohydrate or a source of carbohydrate. The carbohydrate or source of carbohydrate suitable for use in the nutritional powders disclosed herein may be simple, complex, or variations or combinations thereof. Generally, the carbohydrate may include any carbohydrate or carbohydrate source that is suitable for use in oral nutritional compositions and is otherwise compatible with any other selected ingredients or features in the nutritional powder. Non-limiting examples of carbohydrates suitable for use in the nutritional powders described herein include, but are not limited to, maltodextrin; hydrolyzed or modified starch or cornstarch; polydextrose; glucose polymers; corn syrup; corn syrup solids; rice-derived carbohydrate; sucrose; glucose; fructose; lactose; high fructose corn syrup; honey; sugar alcohols (e.g., maltitol, erythritol, sorbitol); isomaltulose; sucromalt; pullulan; potato starch; and other slowly-digested carbohydrates; dietary fibers including, but not limited to, fructooligosaccharides (FOS), galactooligosaccharides (GOS), oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low methoxy pectin, high methoxy pectin, cereal beta-glucans (e.g., oat beta-glucan, barley beta-glucan), carrageenan and psyllium, digestion resistant maltodextrin (e.g., Fibersol™, a digestion-resistant maltodextrin, comprising soluble dietary fiber); soluble and insoluble fibers derived from fruits or vegetables; other resistant starches; and combinations thereof. The nutritional powders described herein may include any individual source of carbohydrate or combination of the various sources of carbohydrate listed above.

In certain embodiments, the nutritional powder includes a fat or a source of fat. The fat or source of fat suitable for use in the nutritional powders described herein may be derived from various sources including, but not limited to, plants, animals, and combinations thereof. Generally, the fat may include any fat or fat source that is suitable for use in oral nutritional compositions and is otherwise compatible with any other selected ingredients or features in the nutritional powder. Non-limiting examples of suitable fat (or sources thereof) for use in the nutritional powders disclosed herein include coconut oil, fractionated coconut oil, soy oil, high oleic soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, fish oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof. Generally, the fats used in nutritional powders for formulating infant formulas and pediatric formulas provide fatty acids needed both as an energy source and for the healthy development of the infant, toddler, or child. These fats typically comprise triglycerides, although the fats may also comprise diglycerides, monoglycerides, and free fatty acids. Fatty acids provided by the fats in the nutritional powder include, but are not limited to, capric acid, lauric acid, myristic acid, palmitic acid, palmitoleic acid, stearic acid, oleic acid, linoleic acid, alpha-linolenic acid, ARA, EPA, and DHA. The nutritional powders can include any individual source of fat or combination of the various sources of fat listed above.

### Optional Ingredients

In certain embodiments, the nutritional powders described herein may further comprise other optional ingredients that may modify the physical, chemical, hedonic, or processing characteristics of the products or serve as additional nutritional components when used for a targeted population. Many such optional ingredients are known or otherwise suitable for use in other nutritional products and may also be used in the nutritional powders described herein, provided that such optional ingredients are safe and effective for oral administration and are compatible with the essential and other ingredients in the selected product form.

Non-limiting examples of such optional ingredients include preservatives, antioxidants, emulsifying agents, buffers, additional nutrients as described herein, colorants, flavors (natural, artificial, or both), thickening agents, flow agents, anti-caking agents, and stabilizers.

In certain embodiments, the nutritional powder may further comprise one or more ingredients that modify the physical characteristics of the powder to provide enhanced air entrainment. Accordingly, in certain embodiments, the nutritional powders comprise at least one of lecithin, phospholipids, silicon dioxide, glycol, and an anti-foam ingredient (e.g., Dow Corning Anti foam FG-10 which is a silicon emulsion).

In certain embodiments, the nutritional powder further comprises minerals, non-limiting examples of which include calcium, phosphorus, magnesium, iron, zinc, manganese, copper, sodium, potassium, molybdenum, chromium, selenium, chloride, and combinations thereof

In certain embodiments, the nutritional powder further comprises vitamins or related nutrients, non-limiting examples of which include vitamin A, vitamin D, vitamin E, vitamin K, thiamine, riboflavin, pyridoxine, vitamin B12, niacin, folic acid, pantothenic acid, biotin, vitamin C, choline, inositol, salts and derivatives thereof, and combinations thereof.

In certain embodiments, the nutritional powder includes one or more masking agents to reduce or otherwise obscure bitter flavors and after taste. Suitable masking agents include natural and artificial sweeteners, natural and artificial flavors, sodium sources such as sodium chloride, and hydrocolloids, such as guar gum, xanthan gum, carrageenan, gellan gum, and combinations thereof. Generally, the amount of masking agent in the nutritional powder may vary depending upon the particular masking agent selected, other ingredients in the nutritional powder, and other nutritional powder or product target variables. Such amounts, however, most typically range from at least 0.1 wt %, including from about 0.15 wt % to about 3 wt %, and also including from about 0.18 wt % to about 2.5 wt %, by weight of the nutritional powder.

In certain embodiments, the nutritional powder includes at least one wetting agent. Generally, wetting agents act to improve and hasten the interaction between the nutritional powder and the impinging liquid, typically water, supplied by the beverage production machine. The wetting agent thus assists in quickly reconstituting the nutritional powder into a suitable liquid product. Suitable wetting agents include phospholipids, mono- and di-glycerides, diacetyl tartaric acid ester of mono- and diglycerides (DATEM), and other emulsifiers and surfactants.

In certain embodiments, the nutritional powders include at least one anti-caking agent. Generally, these agents help to maintain the powder particles as loose, free-flowing particles with a reduced tendency to form large clumps as the powder is stored over time. Suitable anti-caking agents include silicon dioxide.

In certain embodiments, the nutritional powder comprises a compound selected from the group of leucine, beta-alanine, epigallocatechin gallate, human milk oligosaccharides, prebiotics, probiotics, nucleotides, nucleosides, carotenoids (e.g., lutein, beta-carotene, lycopene, zeaxanthin), beta-hydroxy-beta-methylbutyrate (HMB), and combinations thereof Although calcium HMB monohydrate is the preferred source of HMB for use herein, other suitable sources may include HMB as the free acid, a salt, an anhydrous salt, an ester, a lactone, or other product forms that otherwise provide a bioavailable form of HMB from the nutritional product.

### Nutritional Powder Reconstitution

The nutritional powders useful in the methods of the present disclosure may be formulated in any known or otherwise suitable product form for oral or parenteral administration. Oral product forms are generally preferred and include any solid, liquid, or powder formulation suitable for use herein, provided that such a formulation allows for safe and effective oral delivery of the essential and other selected ingredients from the selected product form.

The nutritional compositions may be formulated with sufficient kinds and amounts of nutrients to provide a sole, primary, or supplemental source of nutrition, or to provide a specialized nutritional product for use in individuals afflicted with specific diseases or conditions or with a targeted nutritional benefit. In certain exemplary embodiments, the nutritional product will include protein, fat, and carbohydrate.

The nutritional powder contained in the nutritional powder pods of the present disclosure exhibits generally good reconstitution (e.g., minimal clumping of the nutritional powder), within the limitations of time, temperature, and liquid volume imposed by the beverage production machine.

To ensure adequate delivery of the ingredients in the nutritional powder, the nutritional powder is reconstituted with a defined amount of liquid. Generally, the liquid is mixed with the nutritional powder of the nutritional powder pod to reconstitute the nutritional powder into a liquid product. In certain embodiments, the liquid is passed into and through the nutritional powder pod into a cup or container, mixing with the nutritional powder to reconstitute it into a liquid product. In certain embodiments, the liquid is passed into the nutritional powder pod, mixing with the nutritional powder to reconstitute it into a liquid product. In certain embodiments, the liquid is injected into the nutritional powder pod, mixing with the nutritional product to reconstitute it into a liquid product. In certain embodiments, the liquid product (i.e., the reconstituted nutritional powder) is delivered in a sanitary manner to a receiving container (e.g., a bottle, a Sippy cup, a mug), and the pod is thereafter discarded.

In certain embodiments, the nutritional powder is reconstituted into a liquid product at a rate of from about 10 grams to about 150 grams of powder per 200 mL of liquid, including from about 20 g/200 mL to about 125 g/200 mL, including from about 20 g/200 mL to about 100 g/200 mL, including from about 20 g/200 mL to about 80 g/200 mL, including from about 20 g/200 mL to about 65 g/200 mL, including from about 20 g/200 mL to about 50 g/200 mL, including from about 25 g/200 mL to about 150 g/200 mL, including from about 25 g/200 mL to about 125 g/200 mL, including from about 25 g/200 mL to about 100 g/200 mL, including from about 25 g/200 mL to about 80 g/200 mL, including from about 25 g/200 mL to about 65 g/200 mL, including from about 25 g/200 mL to about 50 g/200 mL, including from about 40 g/200 mL to about 150 g/200 mL, including from about 40 g/200 mL to about 125 g/200 mL, including from about 40 g/200 mL to about 100 g/200 mL, including from about 40 g/200 mL to about 80 g/200 mL, including from about 40 g/200 mL to about 65 g/200 mL, including from about 40 g/200 mL to about 50 g/200 mL, including about 50 g/200 mL to about 150 g/200 mL, including about 50 g/200 mL to about 125 g/200 mL, including about 50 g/200 mL to about 100 g/200 mL, including from about 50 g/200 mL to about 80 g/200 mL, including from about 50 g/200 mL to about 65 g/200 mL, including from about 60 g/200 mL to about 150 g/200 mL, including from about 60 g/200 mL to about 125 g/200 mL, and including about 60 g/200 mL to about 100 g/200 mL. The nutritional powders may also be reconstituted at a rate of 10 grams of powder per 200 mL of liquid, 20 g/200 mL, 25 g/200 mL, 30 g/200 mL, 40 g/200 mL, 50 g/200 mL, 60 g/200 mL, 65 g/200 mL, 75 g/200 mL, 80 g/200 mL, 100 g/200 mL, 125 g/200 mL, and 150 g/200 mL.

Generally, when preparing a liquid product from a nutritional powder pod, it is desirable that the nutritional powder be accurately and fully incorporated into the liquid product. It is undesirable, for instance, for there to be a residue of dry nutritional powder left at the bottom of a container or for the nutritional powder to form clumps that fail to reconstitute in the liquid product. This is particularly important with infant formulas, because these formulas typically provide the sole source or a supplemental source of nourishment to the infant. Generally, when the nutritional powder is an infant formula, the nutritional powder must be fully reconstituted so the infant receives a full serving of nutrients and calories provided by the infant formula. Additionally, any unreconstituted nutritional powder left within the nutritional powder pod is typically discarded, which is wasteful both economically and environmentally. Any unreconstituted powder within a beverage production machine may create clumps that can deposit within or clog the inner workings of the machine, which can create sites for microbial growth and contamination or cause machine failure.

For these reasons, in certain embodiments, the nutritional powder in the nutritional powder pod is essentially reconstituted into the liquid product by the beverage production machine. In certain embodiments, essentially reconstituted means that at least 75% (i.e., 75% to 100%) of the mass of the nutritional powder is reconstituted into the liquid product, including at least about 75%, at least about 80%, at least about 85%, at least about 90%, at least about 92%, at least about 95%, at least about 98%, at least about 100%, and about 75 to about 100%, about 75 to about 98%, about 75 to about 95%, about 75 to about 90%, about 75 to about 85%, about 80 to about 100%, about 80 to about 98%, about 80 to about 95%, about 80 to about 90%, about 85 to about 100%, about 85 to about 98%, about 85 to about 95%, about 90 to about 100%, about 90 to about 98%, about 90 to about 95%, about 92 to about 100%, about 92 to about 98%, about 95 to about 100%, and about 95 to about 98% of the mass of the nutritional powder. The extent of reconstitution of a nutritional powder may be determined according to a variety of methods. One specific method for determining the extent of reconstitution of a nutritional powder is described more fully in the Test Methods section below.

Generally a beverage production machine places certain limitations on the conditions under which reconstitution takes place. For example, the beverage production machine may introduce a specified volume of liquid at a specified temperature into the nutritional powder pod. In certain exemplary embodiments, liquid is reconstituted with the nutritional powder from the pod at a temperature range of about 5° C. to about 60° C., including from about 5° C. to about 50° C. including about 5° C. to about 40° C., including about 5° C. to about 30° C., including about 5° C. to about 20° C., including about 5° C. to about 10° C., including about 10° C. to about 60° C., including about 20° C. to about 60° C., including about 30° C. to about 60° C., including about 40° C. to about 60° C. and also including about 50° C. to about 60° C. In certain exemplary embodiments, the liquid product dispensed from the beverage production machine falls within the temperature range of about 5° C. and about 50° C., including about 5° C. to about 40° C., including about 5° C. to about 30° C., including about 5° C. to about 20° C., including about 5° C. to about 10° C., including about 10° C. to about 50° C., including about 20° C. to about 50° C., including about 30° C. to about 50° C., including about 40° C. to about 50° C.

In order to ensure adequate delivery of the ingredients in the nutritional powder, the nutritional powder is reconstituted with a defined amount of liquid. Generally, the liquid is mixed with the nutritional powder of the nutritional powder pod to reconstitute the nutritional powder into a liquid product. In certain embodiments, the liquid is passed into and through the nutritional powder pod into a cup or container, mixing with the nutritional powder to reconstitute it into a liquid product. In certain embodiments, the liquid is passed into the nutritional powder pod, mixing with the nutritional powder to reconstitute it into a liquid product. In certain embodiments, the liquid is injected into the nutritional powder pod, mixing with the nutritional product to reconstitute it into a liquid product.

In certain exemplary embodiments, the total amount of liquid used to reconstitute the liquid product is within the range of about 0.17 fluid ounce to about 34 fluid ounces (about 5 mL to about 1,000 mL), including about 0.5 fluid ounce to about 34 fluid ounces (about 15 mL to about 1,000 mL), including about 1 fluid ounce to about 17 fluid ounces (about 30 mL to about 500 mL), including about 1 fluid ounce (about 30 mL), including about 2 fluid ounces (about 60 mL), including about 4 fluid ounces (about 120 mL), including about 7 fluid ounces (about 207 mL), including about 8 fluid ounces (about 240 mL), including about 10 fluid ounces (about 296 mL), including about 12 fluid ounces (about 355 mL), including about 14 fluid ounces (about 414 mL), including about 17 fluid ounces (about 500 mL), and also including about 34 fluid ounces (about 1,000 mL). Accordingly, in certain exemplary embodiments, the volume of liquid product dispensed from the beverage product machine is within the range of about 0.17 fluid ounce to about 34 fluid ounces (about 5 mL to about 1,000 mL), including about 0.5 fluid ounce to about 34 fluid ounces (about 15 mL to about 1,000 mL), including about 1 fluid ounce to about 17 fluid ounces (about 30 mL to about 500 mL), including about 1 fluid ounce (about 30 mL), including about 2 fluid ounces (about 60 mL), including about 4 fluid ounces (about 120 mL), including about 7 fluid ounces (about 207 mL), including about 8 fluid ounces (about 240 mL), including about 10 fluid ounces (about 296 mL), including about 12 fluid ounces (about 355 mL), including about 14 fluid ounces (about 414 mL), including about 17 fluid ounces (about 500 mL), and also including about 34 fluid ounces (about 1,000 mL).

In addition, the pressure of the liquid introduced into the nutritional powder pod may affect the amount of air entrained in the resulting reconstituted liquid product. In certain exemplary embodiments, the liquid is reconstituted with the nutritional powder at a pressure ranging from 0.3 bar to 15 bar, including from 0.3 bar to 10 bar, including from 0.3 bar to 7 bar, including from 0.3 bar to 5 bar, including from 0.3 bar to 2 bar, including 0.3 bar to 1 bar, including 1 bar to 10 bar, including 2 bar to 10 bar, including 3 bar to 10 bar, including 5 bar to 10 bar, and including 2 bar to 7 bar. In certain embodiments, the liquid product (i.e., the reconstituted beverage) is delivered in a sanitary manner to the receiving container (e.g., a bottle, sippy cup, mug), and the pod is thereafter discarded.

In certain exemplary embodiments, the nutritional powder is reconstituted within a defined period of time to render the liquid nutritional product suitable for oral consumption. In certain exemplary embodiments, the nutritional powder is reconstituted into the reconstituted nutritional liquid within a time ranging from about 10 seconds to about 300 seconds, including about 10 seconds to about 240 seconds, including a range of about 10 seconds to about 180 seconds, including a range of about 10 seconds to about 120 seconds, including a range of about 10 seconds to about 60 seconds, including a range of about 20 seconds to about 300 seconds, including a range of about 20 seconds to about 240 seconds, including a range of about 20 seconds to about 180 seconds, including a range of about 20 seconds to about 120 seconds, including a range of about 20 seconds to about 60 seconds, including a range of about 30 seconds to about 300 seconds, including a range of about 30 seconds to about 240 seconds, including a range of about 30 seconds to about 180 seconds, including a range of about 30 seconds to about 120 seconds, including a time of less than about 60 seconds (i.e., about 5 to about 60 seconds), including a time of less than about 50 seconds, including a time of less than about 40 seconds, including a time of less than about 30 seconds. In certain exemplary embodiments, the nutritional powder is reconstituted within a time of from about 20 seconds to about 45 seconds.

The reconstitution of a nutritional powder may be determined by a variety of methods. One particular method for testing the reconstitution of a nutritional powder is described below in the Nutritional Powder Reconstitution Test section. A nutritional powder is deemed to have good reconstitution if the reconstitution yield is at least about 75 wt. % of the nutritional powder, including at least about 80 wt. %, at least about 85 wt. %, at least about 90 wt. %, at least about 92 wt. %, at least about 95 wt. %, at least about 97 wt. %, at least about 98 wt. %, or at least about 99 wt. % of the nutritional powder. In certain embodiments, the nutritional powder contained in the nutritional powder pod of the present disclosure has a reconstitution yield of at least about 75 wt. %, including at least about 80 wt. %, at least about 85 wt. %, at least about 90 wt. %, at least about 92 wt. %, at least about 95 wt. %, at least about 97 wt. %, at least about 98 wt. %, or at least about 99 wt. % of the nutritional powder. In certain embodiments, the nutritional powder contained in the nutritional powder pod of the present disclosure has a reconstitution yield of from about 80 wt. % to about 100 wt. %.

The Nutritional Powder Reconstitution Test can also be used to determine the rate of reconstitution of the nutritional powder contained in the nutritional powder pods of the present disclosure. In certain embodiments, the nutritional powder contained in the nutritional powder pod has a rate of reconstitution of from about 0.1 mg/g-sec to about 25 mg/g-sec. In certain exemplary embodiments, the nutritional powder has a rate of reconstitution of from about 0.5 mg/g-sec to about 25 mg/g-sec, including from about 1 mg/g-sec to about 25 mg/g-sec, from about 5 mg/g-sec to about 25 mg/g-sec, from about 10 mg/g-sec to about 25 mg/g-sec, from about 15 mg/g-sec to about 25 mg/g-sec, and also including from about 20 mg/g-sec to about 25 mg/g-sec. In certain exemplary embodiments, the nutritional powder has a rate of reconstitution of from about 1 mg/g-sec to about 15 mg/g-sec, including from about 1.5 mg/g-sec to about 15 mg/g-sec, from about 2 mg/g-sec to about 15 mg/g-sec, from about 2.5 mg/g-sec to about 15 mg/g-sec, and also including from about 5 mg/g-sec to about 15 mg/g-sec. Without being bound by theory, it is believed that as a result of being within the specified rate of reconstitution, the nutritional powder contained within the nutritional powder pod exhibits generally good reconstitution (e.g., minimal clumping of the nutritional powder) when the nutritional powder pod is used in a beverage production machine.

### Methods of Manufacture

Generally, the nutritional powders contained within the pods may be manufactured by any known or otherwise suitable method for making nutritional products including use of intermediary nutritional liquids such as emulsions. Generally, nutritional powders suitable for use in nutritional powder pods may be prepared by any process or suitable method for making a nutritional powder. In some embodiments, the nutritional powders may include spray dried powders, dry blended powders, agglomerated powders, extruded powders, milled powders, powders prepared by other suitable methods, or combinations thereof. In certain embodiments, the process of preparing the nutritional powders includes spray drying, dry blending, agglomerating, extruding, milling, and combinations thereof.

In one suitable manufacturing process for preparing nutritional powders suitable for use in the nutritional powder pods described herein, at least three separate slurries are prepared, including a protein-in-fat (PIF) slurry, a carbohydrate-mineral (CHO-MIN) slurry, and a protein-in-water (PIW) slurry. The PIF slurry is formed by heating and mixing an oil (e.g., soy oil, canola oil, or corn oil) and then adding an emulsifier (e.g., lecithin), fat soluble vitamins, and at least a portion of the total protein (e.g., milk protein concentrate) with continued heat and agitation. The CHO-MIN slurry is formed by adding to water, with heat and agitation, minerals (e.g., potassium citrate, dipotassium phosphate, or sodium citrate), including trace and ultra trace minerals (TM/UTM premix), and thickening or viscosity agents (e.g., cellulose gel, gellan, or carrageenan). The resulting slurry is held for 10 minutes with continued heat and agitation before adding additional minerals (e.g., potassium chloride, magnesium carbonate, or potassium iodide) and the carbohydrates (e.g., sucrose or corn syrup) to complete the CHO-MN slurry. The PIW slurry is formed by mixing water and the remaining protein with heat and agitation.

In accordance with this process, the three slurries are mixed together with heat and agitation to form a nutritional emulsion. The pH of the nutritional emulsion is adjusted to the desired range, e.g., from 6.6 to 7.5 (including 6.6 to 7), after which the nutritional emulsion is subjected to high-temperature short-time (HTST) processing (i.e., about 165° F. (74° C.) for about 16 seconds) or an ultra high temperature (UHT) processing step (i.e., about 292° F. (144° C.) for about 5 seconds). The nutritional emulsion is heat treated, emulsified, homogenized, and cooled during the HTST or UHT process. Water soluble vitamins and ascorbic acid are added (if applicable), the pH is again adjusted (if necessary). The batch is evaporated, heat treated and spray dried. After drying, the powder may be transported to storage hoppers. The base powder may be dry blended with the remaining ingredients to form the nutritional powder. The nutritional powder is then packaged in appropriate containers (i.e., pods, packages containing one or more pods, or kits containing one or more pods) for distribution. Those of skill in the art will understand that standard intermediate manufacturing steps, such as bulk storage, packing in large bags or drums, transport to other locations, etc., may be incorporated as part of this process.

One exemplary method of preparing a spray dried nutritional powder suitable for use in the nutritional powder pods disclosed herein comprises forming and homogenizing an aqueous slurry or liquid comprising predigested fat, and optionally protein, carbohydrate, and other sources of fat, and then spray drying the slurry or liquid to produce a spray dried nutritional powder. The method may further comprise the step of spray drying, dry mixing, or otherwise adding additional nutritional ingredients, including any one or more of the ingredients described herein, to the spray dried nutritional powder.

Generally, when the nutritional powder for use in the nutritional powder pod is a spray dried nutritional powder or a dry blended nutritional powder, it may be prepared by any suitable known techniques. For example, the spray drying may include any spray drying technique that is suitable for use in the production of nutritional powders. Many different spray drying methods and techniques are known for use in the nutrition field, all of which are suitable for use in the manufacture of the spray dried nutritional powders herein. Following drying, the finished powder may be packaged into nutritional powder pods.

In other embodiments, the preparation of the nutritional powder comprises an extruded powder. Milling can also be included as a step in preparing the nutritional powder.

In certain embodiments, the ingredients of the nutritional powder may be extruded as part of the process of making the nutritional powder. In certain embodiments, the ingredients are incorporated in the extruder hopper in the form of a dry feed or powder premix. The dry nutritional ingredients enter the extruder just after the point of entry of water. In certain embodiments, the water comprises from about 1% to about 80% by weight of the total weight of the water and dry ingredients. The amount of water added to the nutritional composition may be adjusted within the aforementioned ranges based on the desired physical properties of the extrudate. In certain embodiments, the nutritional ingredients may be premixed with water to form a thick emulsion, which is then fed into the extruder hopper in the form of a viscous liquid or sludge. The term “extrudate” refers to all or a portion of a nutritional composition that exits an extruder.

In certain embodiments, the extruder used to produce the nutritional powder or extrudate operates in a continuous format. Generally, any extruder known for use in food processing may be utilized. In certain embodiments, extrusion is performed via a screw extruder. Said screw extruder may be a twin screw extruder or a single screw extruder. The extruder screws may consist of shear elements, mixing elements, conveying elements, kneading elements, emulsifying elements, disc elements, or a combination of the above in any interchangeable order. The barrels of the extruder may be steam heated or electrically heated. In certain embodiments, extrusion takes place at a temperature between about 25° C. to about 225° C., from about 50° C. to about 125° C., or from about 70° C. to about 100° C. In certain embodiments, the ingredients are processed in the extruder for about 5 seconds to about 240 seconds or for about 30 seconds to about 180 seconds.

In certain embodiments disclosed herein, the extrudate is dried following extrusion so as to remove most or all of the water contained therein. In such embodiments, any conventional drying methods may be used to remove the desired amount of water from the nutritional powder. For example, the nutritional powder extrudate may be dried using a vacuum, convective hot air, a tray dryer, infrared, or any combination of the above. In certain embodiments, the nutritional powder extrudate may be further ground or milled to a desired particle size following drying. In certain embodiments, additional protein and carbohydrate ingredients may be added to the final nutritional powder in the form of dry ingredients or a dry blend.

In certain embodiment, in order to increase or enhance the total void volume of the nutritional powder, a pressurized gas may be introduced into the nutritional emulsion at a suitable time during the manufacturing process. This pressurized gas may dissolve into the nutritional emulsion during the blending stages if these stages are similarly conducted under pressure. During the spray-drying or extrusion stages, though, the pressure may be reduced, allowing the depressurized gas to bubble out of the particles of nutritional powder that are being formed at this stage. The exiting gas bubbles may leave a greater number of open pores or expanded open pores in the nutritional powder particles.

In certain embodiments, after the nutritional powder is packaged into the pod, the pod is sealed and then stored under ambient conditions or under refrigeration for up to 36 months or longer, more typically from about 6 months to about 24 months. In certain embodiments, a package is provided containing a plurality of nutritional powder pods. In certain embodiments, a package containing a plurality of nutritional powder pods is prepared and stored. In certain exemplary embodiments, the nutritional powder may be packaged in the pod such that a headspace in the pod includes a maximum of about 10% O₂ (i.e. less than or equal to about 10% O₂), thereby reducing oxidation of the nutritional powder or formula and preventing the development of undesirable flavors, smells, and textures. Generally, the pod body is molded or otherwise constructed of a food-safe material, e.g., a plastic such as polypropylene or polyethylene, a metal or metal foil such as steel or aluminum, a natural product such as paper or other fiber based material, and combinations thereof.

### Methods of Use

The exemplary nutritional powder pods described herein are generally designed and configured for use with a beverage production machine to prepare a liquid product. In one exemplary embodiment, a liquid product is prepared according to the following process: using a nutritional powder pod with a beverage production machine to mix a liquid with the nutritional powder pod such that the nutritional powder contained therein is reconstituted, thereby producing a liquid product.

In certain embodiments, an individual consumes one or more servings of the liquid product made using the nutritional powder pods with a beverage production machine. The serving size may be different for different types of individuals, depending on one or more factors including, but not limited to, age, body mass, gender, species, or health.

In these embodiments, an individual desirably consumes at least one serving of the liquid product made using the nutritional powder pods per day, and in some embodiments, may consume two, three, or even more servings per day. Each serving is desirably administered as a single undivided serving, although the serving may also be divided into two or more partial or divided servings to be taken at two or more times during the day.

The methods of the present disclosure include continuous day after day administration of the liquid product made using the nutritional powder pods, as well as periodic or limited administration of the liquid product made using the nutritional powder pods, although continuous day after day administration of the liquid product is generally desirable. The liquid product made using the nutritional powder pods may be used by infants, toddlers, children, and adults.

### Test Methods

The following discussion of test methods should be considered to be exemplary only and not construed to be limiting upon the present disclosure. Specifically, other test methods and variations of the provided test methods may be used, in certain embodiments, to measure the same physical properties or characteristics of a nutritional powder.

### Vibrated Bulk Density Test

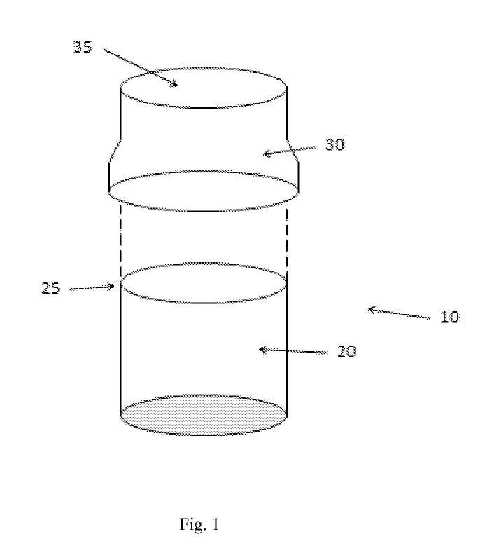

Generally, the following test method is used to measure the bulk density of a powder that has been compressed by vibration in a reproducible manner. More specifically, the test method uses a test cylinder (e.g., the Plexiglas® bulk density test cylinder 10, illustrated in FIG. 1, which comprises a calibrated bottom portion 20 and a top portion 30) having a top portion and bottom portion capable of being separated. Preferably, the volume of the bottom portion of the test cylinder is calibrated and permanently labeled thereon.

The bottom portion of the test cylinder is weighed to determine the tare weight. The top portion of the test cylinder is then placed on top of the bottom portion of the test cylinder. The test cylinder is then filled to near overflowing with the test powder (e.g., through the opening 35 at the top of the top portion 30). A powder funnel may be used to simplify this task. Visible air gaps or unfilled portions of the cylinder should be avoided.

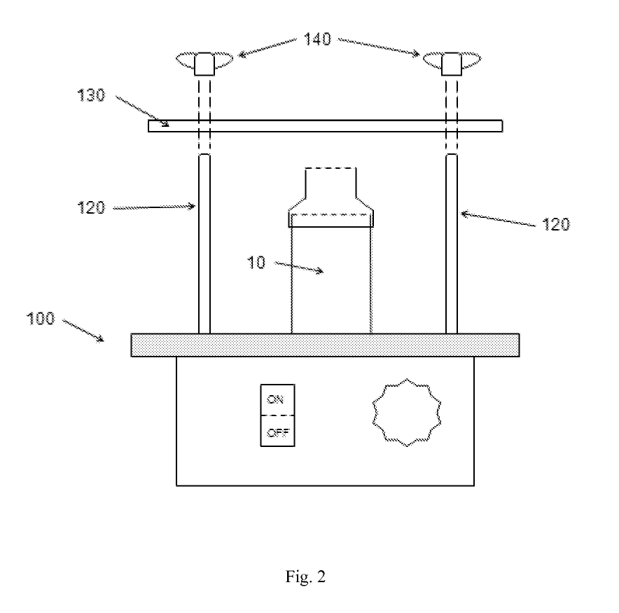

The cylinder (e.g., test cylinder 10) is placed on or in a vibration apparatus (e.g., a modified Syntron® J-1A portable jogger 100, as illustrated in FIG. 2). The cylinder (e.g., test cylinder 10) is secured to the vibration apparatus (e.g., placed between the clamping rods 120 and clamped in place with the clamping strap 130 and wing nuts 140). A predetermined amount of vibration is then applied to the cylinder using the vibration apparatus (e.g., the modified vibration table 100 is set to a predetermined amplitude {e.g., amplitude=0.04-0.045 in, frequency=60 Hz}, and the test cylinder is vibrated for a 60-second vibration cycle).

When the vibration cycle is complete, the test cylinder is unclamped and removed from the vibration apparatus (e.g., table 100). Any excess or loose powder is removed and the top of the cylinder is removed (e.g., over an appropriate waste receptacle, the top section 30 of the test cylinder is carefully removed; using a spatula, the excess powder sample above the mouth 25 of the bottom section 20 of the test cylinder is struck off such that the powder contained in the bottom section 20 is smooth and flush with the mouth 25; using a dry cloth, any powder clinging to the outside of the bottom section 20 is removed).

The bottom section of the test cylinder with the vibrated powder sample is then weighed to determine the gross weight. The vibrated bulk density of the powder is calculated as follows:

$$\frac{[ Gross weight ( g ) ] - [ Tare weight ( g ) ]}{[ Calibrated test cylinder volume ( cc ) ]} = Vibrated Bulk Density ( g \text{/} cc )$$

### Entrained Air Test

The amount of entrained air in a reconstituted liquid nutritional product that is reconstituted according to conventional preparation methods may be quantified as follows: a predetermined amount, for example, 25 g to 65 g of a nutritional powder is reconstituted with 200 ml of tap water at room temperature in an 8 oz. clear plastic bottle. (If the nutritional powder is contained within a pod, it is removed from the pod and measured to obtain the appropriate mass.) The bottle is placed into a mechanical shaker and shaken at a speed of about 4 cycles/second for 5 seconds. A sample of the reconstituted liquid nutritional product is then collected in an appropriate air measuring device and subjected to compression according to the manufacturers specifications. One specific air measuring device suitable for measuring the amount of entrained air in a reconstituted liquid nutritional product is the QuickAir_OC1™ by Papec, LLC 2589 W. Maracay Way, Meridian, Id., USA 83646.

A method for measuring the amount of entrained air in a reconstituted liquid product is as follows: a predetermined amount, for example, 25 g to 65 g of a nutritional powder in a nutritional powder pod is reconstituted with 200 mL of water. Generally, a nutritional product pod is placed into a beverage production machine and the amount of entrained air is measured by collecting a sample of the reconstituted liquid nutritional product and subjecting the sample to compression in an appropriate air measuring device, for example, the PA Squeezer_V3. In general, the amount of foam in the reconstituted liquid product as it exits a beverage production machine is measured. The product is poured into the sample tube of the measuring device and the cap is replaced. The tube is tilted slightly with the bleed valve open to remove the air pocket. The Compression Piston is rotated clockwise until bubbles come out of the bleed valve. The bleed valve is then closed and the Compression Piston is rotated clockwise until the product rises to the black score mark on the Pressure Indicating Tube. The entrained air is calculated by using the number of recorded turns, including fractions, of the Compression Shaft. The entrained air is reported as a percentage using the following calculation:

Entrained air=(turns(total including fraction)−0.5)*2.2.

0.5=dead volume which is determined at the factory, 2.2=calibration factor

### Foam Amount Test

The amount of foam in a reconstituted liquid nutritional product that is reconstituted according to conventional preparation methods may be quantified as follows: a predetermined amount, for example, 25 g to 65 g of a nutritional powder is reconstituted with 200 ml of tap water at room temperature in an 8 oz. clear plastic bottle. (If the nutritional powder is contained within a pod, it is removed from the pod and measured to obtain the appropriate mass.) The bottle is placed into a mechanical shaker and shaken at a speed of about 4 cycles/second for 5 seconds. Approximately two-thirds of the sample is then immediately poured into a 250-ml cylinder. The remaining liquid is swirled in the bottle to capture any remaining foam in the bottle and poured into the cylinder.

An alternative method for measuring the amount of foam in a reconstituted liquid product is as follows: a predetermined amount, for example, 25 g to 65 g of a nutritional powder in a nutritional powder pod is reconstituted with 210 mL of water. The reconstituted liquid nutritional product is dispensed into an 8 oz. clear plastic bottle. Generally, the amount of foam in the reconstituted liquid product as it exits a beverage production machine is measured. A nutritional product pod is placed into a beverage production machine and the amount of foam is measured by pouring approximately two-thirds of the reconstituted liquid product into a graduated cylinder. The remaining liquid is swirled in the container to capture any remaining foam and poured to the cylinder. The amount of foam (ml) is measured by visual inspection in the graduated cylinder.

### Nutritional Powder Reconstitution Test

Generally, a nutritional powder reconstitution test can be used to evaluate how thoroughly the nutritional powder is reconstituted under the operating conditions of a beverage production machine, and to determine a corresponding reconstitution rate.

According to this test, multiple same size portions (e.g., triplicate portions of 2-5 g samples) are taken from the same batch of the nutritional powder to be tested. These portions are weighed both before and after drying by conventional drying techniques (e.g., convection or IR can be utilized) to determine the initial moisture content of each portion (i.e., the weight lost to drying). The average initial moisture content (by weight) is then determined by averaging the results from the multiple portions.

Preweighed portions of each test sample of the nutritional powder are enclosed in resealable nutritional powder pods for the reconstitution testing. Example amounts of the test samples of the nutritional powder range from 2-150 grams.

The test system may be a working beverage production machine, or a model system configured to simulate a beverage production machine and operating under specified conditions. The test system is configured to accommodate and operate under the operating conditions of a beverage product machine, as follows. The pressure within the pod, as well as the temperature of the water that contacts the nutritional powder and the amount of water flowing through the pod are controlled and measurable.

For the reconstitution test, the pod containing the test sample of the nutritional powder is inserted into the test system, and the system is set to deliver a certain amount of water (e.g., about 25-500 mL) at a certain temperature (e.g., in the range of 5-60° C.) under a certain pressure (e.g., 0.3-15 bar, or approximately 5-217 psia) into and through the pod. Under this test, the ratio of powder weight (grams) to water weight (grams) (where the density of water is taken to be 1 g/mL) is lower than 1:1 (e.g., 1:1.1, 1:1.2, 1:1.3, 1:2, 1:3, 1:5, etc.). In other words, relatively less powder (in grams) is used as compared to the amount (in grams) of water. A sufficiently large collection bottle is placed under the dispenser of the test system to receive the homogeneous liquid product output. The test system is started, and the homogeneous liquid product is collected in the collection bottle.

### Reconstitution Time

During the nutritional powder reconstitution test, described above, the reconstitution time is determined by measuring the time that elapses from the initiation time until the reconstituted product is observed to be fully delivered to the collection bottle.

### Rate of Reconstitution

The rate of reconstitution is determined using the general test method and system for the Nutritional Powder Reconstitution Test described above, except that the reconstituted liquid product is collected over 5-second intervals in sequentially-numbered collection vessels. The mass of collected powder in the reconstituted liquid product in each collection vessel is measured using any standard drying technique (e.g., forced air oven, infrared heating, microwave drying, etc.) to remove the water from the collected reconstituted liquid product. The rate of reconstitution is then determined by dividing the weight of total reconstituted solids, i.e., the mass of collected powder (milligram) by the original mass of nutritional powder in the pod (gram) and the collection time interval (seconds), thereby resulting in a “milligram/gram-second” value.

### Reconstitution Yield

The reconstitution yield is determined using the general test method and system described for the Nutritional Powder Reconstitution Test described above. The Nutritional Powder Reconstitution test is run, and the residual powder remaining in the pod is measured. A known amount of water is dispensed into the pod to rinse out the residual powder, and this rinsing water with the residual powder is emptied into a collection vessel. The total solids in the rinsing water is measured using any standard drying technique (e.g., via a forced air oven or microwave drying technique) to remove the water from the rinsings. The total solids in the rinsing water is determined and divided by the percentage of dry-weight solids in the original powder. Finally, the reconstitution yield, which relates to the mass of reconstituted powder in the final liquid product, is determined by subtracting the ratio of the mass of powder remaining in the pod to mass of powder originally in the pod from 1. The reconstituted yield can be reported in the units of “milligram/milligram” (mg/mg) or converted to a percentage (e.g., milligram/milligram×100%).

### EXAMPLES

The following paragraphs describe and demonstrate exemplary embodiments of the nutritional powders described herein. The exemplary embodiments are provided solely for the purpose of illustration and are not to be construed as limitations of the present disclosure, as many variations thereof are possible without departing from the spirit and scope of the present disclosure. The exemplary nutritional powders may be prepared in accordance with the methods described herein.

Example 1A illustrates an exemplary nutritional powder that is formulated as an infant formula. All ingredient amounts are listed as pounds (lb) per 1,000 lb batch of nutritional powder.

TABLE 3

| | Example 1A (Quantity (lb) |
|---|---|
| Ingredients | per 1,000 lb batch) |
| Lactose | 388.31 |
| Non-Fat Dry Milk | 203.16 |
| High Oleic Safflower Oil | 115.89 |
| Soy Oil | 88.04 |
| Coconut Oil | 81.09 |
| Galactooligosaccharides | 66.87 |
| Whey Protein Concentrate | 50.00 |
| Potassium Citrate | 9.16 |
| Lecithin | 5.00 |
| Calcium Carbonate | 4.03 |
| Arachidonic Acid | 3.69 |
| Potassium Chloride | 1.25 |
| Docosahexaenoic Acid | 1.11 |
| Magnesium Chloride | 1.03 |
| Sodium Chloride | 0.59 |
| Choline Chloride | 0.43 |
| Vitamin ADEK | 0.39 |
| Ascorbyl Palmitate | 0.37 |
| Mixed Carotenoid Premix | 0.35 |
| Mixed Tocopherols | 0.16 |
| Ascorbic Acid | 1.27 |
| Riboflavin | 0.003 |
| L-Carnitine | 0.026 |
| Vitamin/Mineral Premix | 1.11 |
| Ferrous Sulfate | 0.45 |
| Nucleotide/Choline | 2.33 |

Example 1B illustrates an exemplary nutritional powder that is formulated as a soy-protein containing infant formula. All ingredient amounts are listed as kilogram (kg) per 1,000 kg batch of nutritional powder.

TABLE 4

| | Example 1B | |
|---|---|---|
| | (Quantity (kg) per | |
| Ingredients | 1,000 kg batch) | |
| Corn Syrup | 504.1 | |
| Soy Protein Isolate (5% DH) | 144.8 | |
| Sunflower Oil | 112.5 | |
| Sucrose | 98.3 | |
| Soy Oil | 83.9 | |
| Coconut Oil | 75.6 | |
| Fructooligosaccharides | 17 | |
| Potassium Citrate | 16.5 | |
| Calcium Phosphate | 16.4 | |
| Sodium Chloride | 3.8 | |
| Arachidonic Acid Oil | 3 | |
| Magnesium Chloride | 2.8 | |
| L-Methionine | 1.7 | |
| Ascorbic Acid | 1.1 | |
| Docosahexaenoic Acid Oil | 1.1 | |
| Lutein | 945.0 | mg |
| Choline Chloride | 507.7 | g |
| Taurine | 457.5 | g |
| Inositol | 353.0 | g |
| Ascorbyl Palmitate | 347.5 | g |
| Ferrous Sulfate | 319.2 | g |
| Mixed Tocopherols | 157.2 | g |
| L-Carnitine | 112.7 | g |
| Niacinamide | 97.9 | g |
| D-Alpha-Tocopheryl Acetate | 78.8 | g |
| Calcium D-Pantothenate | 58.7 | g |
| Zinc | 56.0 | g |
| Iron | 16.9 | g |
| Thiamine | 15.2 | g |
| Vitamin A Palmitate | 14.8 | g |
| Copper | 7.2 | g |
| Riboflavin | 6.7 | g |
| Pyridoxine Hydrochloride | 6.1 | g |
| Folic Acid | 2.1 | g |
| Potassium Iodide | 1.1 | g |
| Phylloquinone | 857.1 | mg |
| Vitamin D3 | 47 | mg |
| Lycopene | 980.0 | mg |
| Biotin | 592.5 | mg |
| Beta-Carotene | 215.6 | mg |
| Selenium | 147.0 | mg |
| Cyanocobalamin | 71.3 | mg |

Example 2 illustrates an exemplary nutritional powder that is formulated as a pediatric formula. All ingredient amounts are listed as kilogram (kg) per 1,000 kg batch of nutritional powder.

TABLE 5

| | Example 2 | |
|---|---|---|
| | (Quantity (kg) per | |
| Ingredients | 1,000 kg batch) | |
| Maltodextrin | 300.0 | |
| Sucrose | 288.0 | |
| Milk Protein Concentrate (80%) | 121.1 | |
| Soy Oil | 82.0 | |
| High Oleic Sunflower Oil | 69.5 | |
| Whey Protein Concentrate | 27.9 | |
| MCT Oil | 26.7 | |
| Soy Protein Isolate | 24.4 | |
| Fructooligosaccharides | 22.9 | |
| Potassium Citrate | 7.1 | |
| Flavor | 6.7 | |
| Magnesium Phosphate Dibasic | 5.7 | |
| Potassium Chloride | 4.3 | |
| Sodium Chloride | 3.7 | |
| Tricalcium Phosphate | 3.2 | |
| Vitamin/Mineral Premix | 2.5 | |
| Docosahexaenoic Acid | 2.0 | |
| Choline Chloride | 1.7 | |
| Potassium Phosphate Monobasic | 1.5 | |
| Calcium Carbonate | 1.4 | |
| Potassium Phosphate Dibasic | 1.2 | |
| Ascorbic Acid | 871.7 | grams |
| Arachidonic Acid | 645.0 | grams |
| Ascorbyl Palmitate | 502.1 | grams |
| Vitamin ADEK Premix | 176.5 | grams |
| Lactobacillus Acidophilus | 100.0 | grams |
| Tocopherol Antioxidant | 83.7 | grams |
| dl-Alpha Tocopheryl Acetate | 49.5 | grams |
| Bifidobacterium Lactis | 35.0 | grams |
| Vitamin A Palmitate | 1.2 | grams |
| Potassium Iodide | 89.2 | milligrams |

| | |
|---|---|
| Sodium Citrate | As Needed |
| Magnesium Chloride | As Needed |
| Citric Acid (processing aid) | As Needed |
| Potassium Hydroxide | As Needed |

Example 3 illustrates an exemplary nutritional powder that is formulated as an adult nutritional product. All ingredient amounts are listed as kilogram (kg) per 1,000 kg batch of nutritional powder.

TABLE 6

| | Example 3 | |
|---|---|---|
| | (Quantity (kg) per | |
| Ingredients | 1,000 kg batch) | |
| Maltodextrin | 268.7 | |
| Corn Syrup Solids | 192.7 | |
| Milk Protein Concentrate (80%) | 133 | |
| Sucrose | 112.4 | |
| High Oleic Sunflower Oil | 85.3 | |
| Soy Oil | 38.5 | |
| Soy Protein Isolate | 54.7 | |
| Fructooligosaccharides | 21.9 | |
| Inulin | 21.9 | |
| Canola Oil | 13.8 | |
| Sodium Citrate | 12.8 | |
| Potassium Citrate | 11.7 | |
| Flavor | 7.3 | |
| Magnesium Chloride | 6.3 | |
| Potassium Chloride | 4.2 | |
| Tricalcium Phosphate | 3.5 | |
| Choline Chloride | 1.7 | |
| Ascorbic Acid | 880.0 | grams |
| Calcium Carbonate | 553.0 | grams |
| Water Soluble Vitamin Premix | 485.0 | grams |
| Ultra Trace Mineral/Trace | 430.0 | grams |
| Ascorbyl Palmitate | 164.6 | grams |
| Vitamin AEDK Premix | 146.7 | grams |
| Tocopherol Antioxidant | 82.3 | grams |
| dl-Alpha Tocopheryl Acetate | 44.7 | grams |
| Beta Carotene (30%) | 5.5 | grams |
| Manganese Sulfate | 3.7 | grams |
| Thiamin Hydrochloride | 2.5 | grams |
| Riboflavin | 1.5 | grams |
| Vitamin A Palmitate | 1.2 | grams |
| Potassium Iodide | 913.3 | milligrams |

| | |
|---|---|
| Magnesium Sulfate | As Needed |
| Copper Sulfate | As Needed |
| Citric Acid (processing aid) | As Needed |
| Potassium Hydroxide | As Needed |

Examples 4-26 illustrate certain physical characteristics of exemplary nutritional powders according to the present disclosure. The nutritional powders were prepared according to the methods described previously. The nutritional powders included infant, toddler, and adult formulations.

The reconstitution time and reconstitution yield of the nutritional powders of Examples 4-26 were measured according to the test methods previously described. The flow rate of the water delivered into the nutritional powder pod is set at approximately 15 mL per second. The results are given in Table 7.

TABLE 7

| | Sample | Reconstitution | Reconstitution |
|---|---|---|---|
| Example | Code | Time (sec) | Yield (%) |
| 4 | 1A | 40 | 99.3 |
| 5 | 2A | 40 | 98.8 |
| 6 | 7A | 45 | 99.7 |
| 7 | 8D | 40 | 92.3 |
| 8 | 1D | 40 | 91.1 |
| 9 | 2D | 40 | 99.2 |
| 10 | 3D | 30 | 98.8 |
| 11 | 4D | 25 | 94.1 |
| 12 | 8A | 45 | 99.3 |
| 13 | 9A | 40 | 91.8 |
| 14 | 1C | 35 | 91.5 |
| 15 | 2C | 40 | 94.4 |
| 16 | 3C | 40 | 98.9 |
| 17 | 3A | 40 | 98.8 |
| 18 | 4A | 25 | 82.8 |
| 19 | 6A | 40 | 99.0 |
| 20 | 1B | 35 | 98.9 |
| 21 | 2B | 30 | 96.0 |
| 22 | 9C | 40 | 98.5 |
| 23 | 4B | 45 | 99.3 |
| 24 | 5B | 40 | 98.7 |
| 25 | 6B | 40 | 98.9 |
| 26 | 7B | 45 | 99.0 |
| | Min | 25 | 82.8 |
| | Avg | 38 | 96.5 |
| | Max | 45 | 99.7 |

As seen in Table 7, the exemplary nutritional powders of Examples 4-26 had reconstitution times ranging from about 25 seconds to about 45 seconds, with an average reconstitution time of about 38 seconds. The reconstitution yield of the tested nutritional powders ranged from about 82% to about 99.7%, with an average reconstitution yield of about 96%.

The rate of reconstitution of some of the nutritional powders of Examples 4-26 was measured as described previously. To determine the reconstitution rate, aliquots of the reconstituted liquid were collected in 5-second intervals in separate sample cups. The results are given in Table 8.

Examples 4-26 were reconstituted according to the following procedure to determine the amount of foam and entrained air in the reconstituted composition. The following procedure is designed to provide an approximate reconstitution of a nutritional powder by hand. Approximately 210 mL of water having a temperature of 105-110° F. is metered into a bottle. An amount of powder appropriate for an 8 oz serving is weighed and poured in to the bottle which is then capped. The bottle is held horizontally and shaken vigorously back and forth across a distance of approximately 12 inches at a rate of 121 revolutions per minute for a period of 10 seconds. Once mixed, the reconstituted product is poured slowly down the side of a 250 mL graduated cylinder. The bottle is swirled near the end of the pour to capture as much of the foam as possible. The amount of foam is determined by visual inspection of the cylinder immediately after the pour and again at 15 and 30 minutes post pour. The results are set forth in Table 8.

TABLE 8
Hand Shake Method

| | | | | | | Ratio of |
|---|---|---|---|---|---|---|
| Ex- | Sample | Foam- | Foam-15 | Foam-30 | Entrained | Foam |
| ample | Code | Initial (ml) | min (ml) | min (ml) | air (%) | to Air |
| 4 | 1A | 30 | 10 | 8 | 9 | 3 |
| 5 | 2A | 54 | 50 | 48 | 18 | 3 |
| 6 | 7A | 6 | 4 | 4 | 1 | 11 |
| 7 | 8D | 11 | 10 | 10 | 1 | 20 |
| 8 | 1D | 10 | 10 | 10 | 0 | NAP |
| 9 | 2D | 6 | 6 | 6 | 1 | 11 |
| 10 | 3D | 16 | 14 | 12 | 1 | 15 |
| 11 | 4D | 54 | 44 | 44 | 20 | 3 |
| 12 | 8A | 14 | 8 | 8 | 7 | 2 |
| 13 | 9A | 20 | 14 | 14 | 7 | 3 |
| 14 | 1C | 48 | 42 | 42 | 16 | 3 |
| 15 | 2C | 42 | 30 | 28 | 13 | 3 |
| 16 | 3C | 20 | 15 | 9 | 2 | 9 |
| 17 | 3A | 54 | 48 | 46 | 14 | 4 |
| 18 | 4A | 48 | 42 | 38 | 1 | 87 |
| 19 | 6A | 60 | 27 | 27 | 18 | 3 |
| 20 | 1B | 28 | 20 | 20 | 4 | 7 |
| 21 | 2B | 18 | 12 | 12 | 2 | 8 |
| 22 | 9C | 2 | 2 | 2 | 8.8 | 0.23 |
| 23 | 4B | 30 | 20 | 18 | 9.9 | 3 |
| 24 | 5B | 1 | 2 | 2 | 0.6 | 2 |
| 25 | 6B | 22 | 16 | 10 | 6.6 | 3 |
| 26 | 7B | 2 | 2 | 2 | 0 | NAP |
| | Min | 1 | 2 | 2 | 0 | 0.2 |
| | Avg | 26 | 19 | 18 | 7 | 10 |
| | Max | 60 | 50 | 48 | 20 | 87 |

As seen in Table 8, the exemplary nutritional powders of Examples 4-26 had initial foam amounts ranging from about 1 mL to about 60 mL, with an average initial foam amount of about 26 mL when reconstituted by the hand shake method. Examples 4-26 had foam amounts at 15 minutes ranging from about 2 mL to about 50 mL, with an average foam amount at 15 minutes of about 19 mL. Examples 4-26 had foam amounts at 30 minutes ranging from about 2 mL to about 48 mL, with an average foam amount at 30 minutes of about 18 mL. Examples 4-26 had entrained air percentages ranging from about 0% to about 20%, with an average entrained air percentage of about 7% when reconstituted via the hand shake method described above.

TABLE 9

| | | Reconstitution Rate (mg/g-sec) | | | | | | | | |
|---|---|---|---|---|---|---|---|---|---|---|
| | | | | | | | | 30- | 35- | 40- |
| Ex- | Sample | 0-5 | 5-10 | 10-15 | 15-20 | 20-25 | 25-30 | 35 | 40 | 45 |
| ample | Code | sec | sec | sec | sec | sec | sec | sec | sec | sec |
| 4 | 1A | 18.4 | 4.0 | 0.6 | 0.6 | 0.5 | 0.4 | 0.4 | 0.1 | — |
| 5 | 2A | 16.5 | 4.6 | 1.1 | 1.0 | 1.3 | 1.1 | 0.6 | 0.1 | — |
| 6 | 7A | 16.6 | 2.9 | 0.7 | 1.0 | 0.9 | 1.0 | 0.9 | 0.3 | 0.1 |
| 7 | 8D | 19.7 | 4.9 | 1.1 | 0.8 | 1.3 | 1.1 | 0.9 | 0.2 | — |
| 8 | 1D | 18.1 | 1.8 | 1.3 | 0.8 | 1.0 | 1.1 | 0.8 | 0.3 | — |
| 9 | 2D | 19.6 | 3.7 | 0.6 | 0.4 | 0.5 | 0.5 | 0.4 | 0.1 | — |
| 10 | 3D | 17.2 | 5.3 | 3.1 | 1.8 | 1.8 | 0.7 | — | — | — |
| 11 | 4D | 15.2 | 3.5 | 8.0 | 2.6 | 0.3 | — | — | — | — |
| 12 | 8A | 17.9 | 3.1 | 0.8 | 1.0 | 0.9 | 0.8 | 0.7 | 0.2 | 0.1 |
| 13 | 9A | 18.2 | 5.9 | 1.5 | 0.8 | 1.1 | 1.1 | 1.1 | 0.4 | — |
| 14 | 1C | 16.5 | 5.1 | 3.0 | 3.6 | 1.4 | 0.2 | 0.1 | — | — |
| 15 | 2C | 18.8 | 5.3 | 1.6 | 0.7 | 1.0 | 1.1 | 0.7 | 0.1 | — |
| 16 | 3C | 15.5 | 3.6 | 1.3 | 1.2 | 1.4 | 1.3 | 1.1 | 0.3 | — |
| 17 | 3A | 14.8 | 5.3 | 1.3 | 0.8 | 1.0 | 1.1 | 0.9 | 0.4 | — |
| 18 | 4A | 8.9 | 3.0 | 9.0 | 1.0 | 0.2 | — | — | — | — |
| 19 | 6A | 16.8 | 3.2 | 1.5 | 1.2 | 1.2 | 1.4 | 1.1 | 0.4 | — |
| 20 | 1B | 19.4 | 5.0 | 2.3 | 1.3 | 0.9 | 0.9 | 0.3 | — | — |
| 21 | 2B | 13.7 | 5.5 | 3.2 | 5.1 | 3.3 | 0.7 | — | — | — |
| 22 | 9C | 19.3 | 5.5 | 4.4 | 0.6 | 1.7 | 1.7 | 0.9 | 0.1 | — |
| 23 | 4B | 15.3 | 10.3 | 0.4 | 1.1 | 0.8 | 0.9 | 0.6 | 0.1 | 0.1 |
| 24 | 5B | 8.6 | 5.1 | 4.6 | 3.2 | 2.0 | 2.2 | 0.6 | 0.1 | — |
| 25 | 6B | 16.0 | 3.2 | 1.7 | 1.2 | 1.1 | 1.4 | 1.1 | 0.2 | — |
| 26 | 7B | 12.0 | 7.5 | 3.8 | 0.3 | 0.8 | 1.0 | 1.2 | 0.7 | 0.1 |

The reconstitution rate for all powders was typically greatest during the first 5 to 10 seconds of testing, then dropped during the following test intervals. The exemplary nutritional powders of Examples 4-26 had reconstitution rates in the first 5 seconds ranging from about 9 mg/g-sec to about 20 mg/g-sec, with an average reconstitution rate of about 16 mg/g-sec. The reconstitution rate from 5 to 10 seconds for all tested nutritional powders ranged from about 2 mg/g-sec to about 10 mg/g-sec, with an average reconstitution rate of about 5 mg/g-sec. The reconstitution rate from 10 to 15 seconds for all tested nutritional powders ranged from about 0.4 mg/g-sec to about 9 mg/g-sec, with an average reconstitution rate of about 2 mg/g-sec. The reconstitution rate from 15 to 20 seconds for all tested nutritional powders ranged from about 0.3 mg/g-sec to about 5 mg/g-sec, with an average reconstitution rate of about 1 mg/g-sec. After 20 seconds, the reconstitution rate for all tested nutritional powders was typically less than about 2 mg/g-sec.

Examples 4-26 were reconstituted from a nutritional powder pod via a beverage production machine according to the following procedure to determine the amount of foam and entrained air in the reconstituted composition. Water tanks are set to a temperature of 130° F. An amount of nutritional powder is appropriate for an 8 oz. serving is weighed into a nutritional powder pod. Water is delivered into the pod at a rate of 5 mL per second. Once reconstituted, the reconstituted liquid product is poured slowly down the side of a 250 mL graduated cylinder. The bottle is swirled near the end of the pour to capture as much of the foam as possible. The amount of foam is determined by visual inspection of the cylinder immediately after the pour and again at 15 and 30 minutes post pour. The results are set forth in Table 10.

TABLE 10
Beverage Production Machine

| | | | | | | Ratio of |
|---|---|---|---|---|---|---|
| Ex- | Sample | Foam- | Foam-15 | Foam-30 | Entrained | Foam |
| ample | Code | Initial (ml) | min (ml) | min (ml) | air (%) | to Air |
| 4 | 1A | 7 | 5 | 5 | 1.1 | 6 |
| 5 | 2A | 15 | 12 | 11 | 2.2 | 7 |
| 6 | 7A | 3 | 2 | 2 | 0 | NAP |
| 7 | 8D | 5 | 5 | 5 | 0.6 | 9 |
| 8 | 1D | 4 | 4 | 4 | 0.6 | 7 |
| 9 | 2D | 2 | 2 | 2 | 0 | NAP |
| 10 | 3D | 6 | 6 | 6 | 0.6 | 11 |
| 11 | 4D | 33 | 28 | 24 | 10 | 3 |
| 12 | 8A | 6 | 6 | 5 | 2.2 | 3 |
| 13 | 9A | 6 | 6 | 4 | 0.6 | 11 |
| 14 | 1C | 15 | 12 | 12 | 6.1 | 2 |
| 15 | 2C | 7 | 7 | 6 | 2.2 | 3 |
| 16 | 3C | 9 | 7 | 6 | 0.6 | 16 |
| 17 | 3A | 10 | 8 | 8 | 4.4 | 2 |
| 18 | 4A | 32 | 30 | 28 | 13 | 2 |
| 19 | 6A | 10 | 8 | 8 | 3.9 | 3 |
| 20 | 1B | 16 | 16 | 16 | 7.7 | 2 |
| 21 | 2B | 19 | 18 | 15 | 6.6 | 3 |
| 22 | 9C | 3 | 3 | 2 | 0.6 | 5 |
| 23 | 4B | 3 | 2 | 2 | 0.6 | 5 |
| 24 | 5B | 1 | 1 | 1 | 0.6 | 2 |
| 25 | 6B | 5 | 4 | 4 | 0 | NAP |
| 26 | 7B | 1 | 1 | 1 | 0 | NAP |
| | Min | 1 | 1 | 1 | 0 | 1 |
| | Avg | 9 | 8 | 8 | 3 | 6 |
| | Max | 33 | 30 | 28 | 13 | 16 |

As seen in Table 10, the exemplary nutritional powders of Examples 4-26 had initial foam amounts ranging from about 1 mL to about 33 mL, with an average initial foam amount of about 9 mL when reconstituted with a beverage production machine. Examples 4-26 had foam amounts at 15 minutes ranging from about 1 mL to about 30 mL, with an average foam amount at 15 minutes of about 8 mL. Examples 4-26 had foam amounts at 30 minutes ranging from about 1 mL to about 28 mL, with an average foam amount at 30 minutes of about 8 mL. Examples 4-26 had entrained air percentages ranging from about 0% to about 13%, with an average entrained air percentage of about 3% when reconstituted with a beverage production machine.

Therefore, it has unexpectedly been found that preparation of a liquid product from a nutritional powder pod with a beverage production machine provides liquid nutritional products with reduced air entrainment and foam amount. In particular, a majority of products have lower entrained air when reconstituted with a beverage production machine. Likewise, a majority of products have lower foam amounts when prepared with a beverage production machine as compared to reconstitution using the hand shake method.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The nutritional compositions, infant formulas, and corresponding manufacturing methods of the present disclosure can comprise, consist of, or consist essentially of the essential elements and limitations of the disclosure as described herein, as well as any additional or optional ingredients, components, or limitations described herein or otherwise useful in nutritional powdered formula applications.

The nutritional powders and infant formulas of the present disclosure may also be substantially free of any optional or selected essential ingredient or feature described herein, provided that the remaining powder or formula still contains all of the required ingredients or features as described herein. In this context, and unless otherwise specified, the term “substantially free” means that the selected composition contains less than a functional amount of the optional ingredient, typically less than 0.1% by weight, and also including zero percent by weight of such optional or selected essential ingredient.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the applicants intend to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In some embodiments, it may be possible to utilize the various inventive concepts in combination with one another (e.g., one or more of the first, second, third, etc., exemplary embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment.

Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

1. A method for improving tolerance of an individual upon the individual's ingestion of a reconstituted liquid nutritional product, the method comprising
using a beverage production machine to reconstitute a nutritional powder contained within a pod with a liquid, thereby forming a reconstituted liquid nutritional product, and
providing the reconstituted liquid nutritional product to an individual for consumption,
wherein the reconstituted liquid nutritional product has an air entrainment of about 0% to about 25%.

2. The method of claim 1, wherein the reconstituted liquid nutritional product has a foam volume from about 0 mL to about 70 mL.

3. The method of claim 1, wherein the reconstituted liquid nutritional product is an infant formula.

4. (canceled)

5. The method of claim 1, wherein the improved tolerance is a reduction in one or more of colic, fussiness, intestinal discomfort, spit-up, vomiting, and gassiness.

6. The method of claim 1, wherein the nutritional powder comprises at least one of lecithin, phospholipids, silicon dioxide, glycol, and an antifoaming component.

7-28. (canceled)

29. The method of claim 1, wherein the nutritional powder comprises at least one of: a protein, a carbohydrate, and a fat.

30-31. (canceled)

32. The method of claim 1, wherein the reconstituted liquid nutritional product has an air entrainment of about 0% to about 15%.

33. The method of claim 1, wherein the reconstituted liquid nutritional product has an air entrainment of about 0% to about 10%.

34. The method of claim 1, wherein the reconstituted liquid nutritional product has an air entrainment of about 1% to about 15%.

35. The method of claim 1, wherein the reconstituted liquid nutritional product has an air entrainment of about 1% to about 10%.

36. (canceled)

37. A process for reconstituting a liquid product from a nutritional powder pod, the process comprising:
mixing a liquid with nutritional powder from a nutritional powder pod, thereby forming a reconstituted liquid nutritional product, and
providing the reconstituted liquid nutritional product to an individual for consumption, wherein the reconstituted liquid nutritional product has an air entrainment of about 0% to about 25%.

38. The process of claim 37, wherein the reconstituted liquid nutritional product has a foam volume of about 0 mL to about 70 mL.

39. The process of claim 37, wherein the nutritional powder comprises at least one of: a protein, a carbohydrate, and a fat.

40-50. (canceled)

51. The process of claim 37, wherein the nutritional powder is reconstituted with the liquid at a temperature of about 5° C. to about 50° C.

52. The process of claim 37, wherein total amount of liquid mixed with the nutritional powder is within the range of about 1 fluid ounce (about 30 mL) to about 12 fluid ounces (about 355 mL).

53-64. (canceled)

65. A reconstituted liquid nutritional product produced by using a nutritional powder pod with a beverage production machine to reconstitute the nutritional powder to form a reconstituted liquid nutritional product with an air entrainment of about 0% to about 25%.

66. The reconstituted liquid product of claim 65, wherein the reconstituted liquid product has a foam volume from about 0 mL to about 70 mL.

67. The reconstituted liquid product of claim 65, wherein the reconstituted liquid product comprises at least one of: a protein, a carbohydrate, and a fat.

68. (canceled)

69. The reconstituted liquid product of claim 65, wherein the reconstituted liquid product is an infant formula.

70-71. (canceled)

72. The reconstituted liquid product of claim 65, wherein the reconstituted liquid nutritional product has a ratio of amount of foam to entrained air of about 0 to about 80:1.

73-77. (canceled)
